(19) United States
(12) Patent Application Publication
(10) Pub. No.: US 2026/0349867 A1
(43) Pub. Date: Nov. 5, 2026

(54) AI-BASED RUNTIME ISSUE ROOT CAUSE DETERMINATION BY PROVIDING A TOOL TO DYNAMICALLY GATHER APPLICATION INFORMATION AT RUNTIME

(71) Applicant: Microsoft Technology Licensing, LLC, Redmond, WA (US)

(72) Inventors: James Michael NEWTON-KING, Singapore (SG); Stephen Harris TOUB, Winchester, MA (US)

(21) Appl. No.: 19/198,997

(22) Filed: May 5, 2025

(51) Int. Cl. G06F 11/07; G06F 11/36; G06F 11/3604

(52) U.S. Cl. CPC G06F 11/079; G06F 11/0793; G06F 11/3612; G06F 11/0766; G06F 11/0769; G06F 11/36

(57) ABSTRACT

Techniques described herein enable AI-based runtime issue root cause determination by providing a tool to dynamically gather application information at runtime of an application. A subset of data items is determined based on relevance to a runtime issue regarding an application under development. An AI model is caused to determine whether the application has the runtime issue and/or a root cause of the runtime issue by providing a description of a tool that is configured to dynamically gather identified data items in the subset of the data items from at least a subset of resources that define the application while the application is executing. An AI response that indicates the root cause is received from the AI model. An action is performed with regard to the runtime issue (e.g., an indication of the root cause is provided via a user interface).

### BACKGROUND

Modern applications often include multiple resources that work together to create a final product. When debugging an error that is encountered by such an application, it may be challenging to determine a source of the error. Although telemetry typically is gathered from the resources to facilitate a determination of the source of the error, the telemetry may be cryptic and difficult to understand and to correlate across a multitude of sources. In an example scenario, the error impacts a frontend resource of the application, but a source of the error is in a database server that the application did not call. For instance, the frontend resource may have called an external resource, which then called the database server, which then encountered the error, and the error may have then propagated through other resources in the application, including the frontend resource. Even if an error message is generated to identify the error, the error message may be confusing, vague, or specific to a particular piece of technology with which a developer of the application has limited or no experience.

### SUMMARY

It may be desirable to use an artificial intelligence (AI) model to determine a root cause of a runtime issue that is encountered by an application under development. A root cause of a runtime issue is a fundamental reason for occurrence of the runtime issue. In an aspect, the runtime issue would not have occurred but for the root cause. A runtime issue is an issue that is encountered by an application during runtime of the application. Runtime of an application is a period of time during which the application is executing. An application under development is an application that is being developed in an application development environment. An application development environment is an environment (e.g., a workspace) that includes components that are usable by a developer to create, test, deploy, debug, and/or profile an application.

In an example real-world implementation, particular information is deemed to be relevant to the runtime issue, and a tool that is configured to gather the particular information is provided to the AI model for the purpose of determining the root cause of the runtime issue. A tool is functionality (e.g., a sub-routine) that is configured to perform a particular type of operation. Example types of an operation include but are not limited to querying a database, executing code (e.g., an executable file), gathering a particular type of data, comparing particular types of data, generating a particular type of output (e.g., a picture, source code, or intermediate code), and instructing another application to perform an operation. Examples of a particular type of data include but are not limited to an application model, a log, and application telemetry. An application model is a model that represents an application. The application model includes definitions and runtime information regarding resources that define the application. A definition of a resource defines a structure (e.g., architecture, modules, layers, components, data models, interfaces, workflow, configuration, source, and/or dependencies) of the resource. For instance, a source of a resource may be source code from which the executable resource is compiled or a container image that is running in a container runtime. Runtime information regarding a resource is information that is gathered from the resource while the resource is executing. A log indicates event(s) and/or error(s) that occur with regard to an application (e.g., one or more of the resources that define the application). An event is an action that occurs with regard to an application. The event may occur synchronously or asynchronously. Two or more events may be correlated. For example correlation between events may enable the AI model to determine a causal chain that led to one or more of the events being issued. For instance, a hypertext transfer protocol (HTTP) client may have called to an HTTP server, which triggered a call to a database that failed. Application telemetry indicates performance and/or usage of an application. Examples of performance include but are not limited to response time, throughput, resource utilization, error rate, latency, uptime, load time, concurrency, scalability, and database performance. Examples of usage include but are not limited to user activity, session duration, and feature usage. In accordance with the real-world implementation, providing the tool to the AI model enables the AI model to determine the root cause of the runtime issue by using the tool to dynamically gather the particular information from at least a subset of resources that define the application while the application is executing.

Various approaches are described herein for, among other things, causing an AI-based runtime issue root cause determination to be performed by providing a tool to an AI model. In an aspect, providing the tool to the AI model enables the AI model to dynamically gather application information at runtime of an application. Application information is information regarding an application. In an example, the application information includes an application model of the application, log(s) associated with the application, and/or application telemetry associated with the application. In another example, the application information covers any number of distinct resources (e.g., services or components) that make up the application. In another aspect, providing the tool to the AI model enables the AI model to perform a test on an application (e.g., to test a hypothesis). In an example of this aspect, the AI model determines that a bug in an application is caused by multiple actions happening simultaneously. In accordance with this example, the AI model uses the tool to run the actions simultaneously. In further accordance with this example, the AI model may execute another tool to review logs that include results of running the actions at the same time.

In a first example approach, a user input is received via a user interface in an application development environment. The user input inquires about a root cause of a runtime issue encountered by an application that is under development. A particular subset of a plurality of data items regarding the application is determined as a result of the particular subset being relevant to the runtime issue. The particular subset is a first subset of the plurality of data items that defines an application model that includes definitions and runtime information regarding a plurality of resources that define the application, a second subset of the plurality of data items that includes a resource log that indicates an event and/or an error that occurs with regard to the plurality of resources, or a third subset of the plurality of data items that includes application telemetry that indicates performance and/or usage of the application. An AI model is caused to determine the root cause of the runtime issue by providing an AI input together with contextual information to the AI model. The AI input requests a determination of the root cause of the runtime issue and indicates a tool that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. An AI response is received from the AI model in response to the AI input. The AI response indicates the root cause of the runtime issue. In response to the user input, an indication of the root cause of the runtime issue is provided via the user interface.

In a second example approach, a user input is received via a user interface in an application development environment. The user input inquires whether an application that is under development has a runtime issue. A particular subset of a plurality of data items that has a relevance to a determination whether the application has the runtime issue that satisfies a relevance criterion is determined. The particular subset is a first subset of the plurality of data items that defines an application model that includes definitions and runtime information regarding a plurality of resources that define the application, a second subset of the plurality of data items that includes a resource log that indicates an event and/or an error that occurs with regard to the plurality of resources, or a third subset of the plurality of data items that includes application telemetry that indicates performance and/or usage of the application. An AI model is caused to determine that the application has the runtime issue and to determine a root cause of the runtime issue by providing an AI input together with contextual information to the AI model. The AI input requests a determination of whether the application has the runtime issue and indicates a tool that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. An AI response is received from the AI model in response to the AI input. The AI response indicates that the application has the runtime issue and further indicates the root cause of the runtime issue. In response to the user input, a first indication that the application has the runtime issue and a second indication of the root cause of the runtime issue are provided via the user interface.

In a third example approach, a particular subset of a plurality of data items, which has a relevance to a determination whether an application that is under development has a runtime issue that satisfies a relevance criterion, is determined. The particular subset is a first subset of the plurality of data items, a second subset of the plurality of data items, or a third subset of the plurality of data items. The first subset defines an application model that includes definitions and runtime information regarding a plurality of resources that define the application. The second subset includes a resource log that indicates an event and/or an error that occurs with regard to the plurality of resources. The third subset includes application telemetry that indicates performance and/or usage of the application. In response to detection of a triggering event, an AI model is caused to determine that the application has the runtime issue and to determine a root cause of the runtime issue by providing an AI input together with contextual information to the AI model. The AI input requests a determination of whether the application has the runtime issue and indicates a tool that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. An AI response is received from the AI model in response to the AI input. The AI response indicates that the application has the runtime issue and further indicates the root cause of the runtime issue. As a result of the AI response indicating that the application has the runtime issue and further indicating the root cause of the runtime issue, an action is performed with regard to the runtime issue.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example AI-based runtime issue root cause determination system in accordance with an embodiment.

FIGS. 2 and 5-10 depict flowcharts of example methods for causing an AI-based runtime issue root cause determination to be performed by providing a tool to dynamically gather application information at runtime of an application in accordance with embodiments.

FIG. 3 depicts a flowchart of an example method for causing an AI model to determine a root cause of a runtime issue by using a tool in accordance with an embodiment.

FIG. 4 depicts a flowchart of an example method for providing an indication of a recommended action in accordance with an embodiment.

FIG. 11 is a block diagram of an example computing system in accordance with an embodiment.

FIG. 12 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to use an artificial intelligence (AI) model to determine a root cause of a runtime issue that is encountered by an application under development. A root cause of a runtime issue is a fundamental reason for occurrence of the runtime issue. In an aspect, the runtime issue would not have occurred but for the root cause. A runtime issue is an issue that is encountered by an application during runtime of the application. Runtime of an application is a period of time during which the application is executing. An application under development is an application that is being developed in an application development environment. An application development environment is an environment (e.g., a workspace) that includes components that are usable by a developer to create, test, deploy, debug, and/or profile an application.

In an example real-world implementation, particular information is deemed to be relevant to the runtime issue, and a tool that is configured to gather the particular information is provided to the AI model for the purpose of determining the root cause of the runtime issue. A tool is functionality (e.g., a sub-routine) that is configured to perform a particular type of operation. Example types of an operation include but are not limited to querying a database, executing code (e.g., an executable file), gathering a particular type of data, comparing particular types of data, generating a particular type of output (e.g., a picture, source code, or intermediate code), and instructing another application to perform an operation. Examples of a particular type of data include but are not limited to an application model, a log, and application telemetry. An application model is a model that represents an application. The application model includes definitions and runtime information regarding resources that define the application. A definition of a resource defines a structure (e.g., architecture, modules, layers, components, data models, interfaces, workflow, configuration, source, and/or dependencies) of the resource. For instance, a source of a resource may be source code from which the executable resource is compiled or a container image that is running in a container runtime. Runtime information regarding a resource is information that is gathered from the resource while the resource is executing. A log indicates event(s) and/or error(s) that occur with regard to an application (e.g., one or more of the resources that define the application). An event is an action that occurs with regard to an application. The event may occur synchronously or asynchronously. Two or more events may be correlated. For example, correlating the events may enable the AI model to determine a causal chain that led to one or more of the events. For instance, a hypertext transfer protocol (HTTP) client may call an HTTP server, which then triggers a call to a database that fails. Application telemetry indicates performance and/or usage of an application. Examples of performance include but are not limited to response time, throughput, resource utilization, error rate, latency, uptime, load time, concurrency, scalability, and database performance. Examples of usage include but are not limited to user activity, session duration, and feature usage. In accordance with the real-world implementation, providing the tool to the AI model enables the AI model to determine the root cause of the runtime issue by using the tool to dynamically gather the particular information from at least a subset of resources that define the application while the application is executing.

An AI model is a model that utilizes artificial intelligence to perform a task in response to an AI input that is received by the AI model. Artificial intelligence is intelligence of a machine (e.g., a computing system) and/or code (e.g., software and/or firmware), as opposed to intelligence of a living creature (e.g., a human). In an aspect, the AI model is an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal. In another aspect, the AI model is a machine learning model. A machine learning model is an AI model that is configured to learn (e.g., acquire intelligence) from data and to make determinations (e.g., predictions) based on the data (e.g., based on the acquired intelligence). In an example implementation, the machine learning model is capable of modifying itself (e.g., its algorithm) to make determinations that are more accurate, precise, and/or relevant to an AI input without being explicitly programmed to do so.

An AI input indicates (e.g., specifies) a task that is to be performed by an AI model. Examples of an AI input include but are not limited to an AI prompt and an application programming interface (API) input. An AI prompt is an AI input that causes (e.g., triggers) an AI model to generate an answer that is responsive to the AI prompt. An answer to an AI prompt is referred to herein as an “AI response.” Examples of an AI prompt include but are not limited to a zero-shot prompt, a one-shot prompt, and a few-shot prompt. A zero-shot prompt is a prompt that indicates a task to be performed by an AI model that has not been trained on example(s) of the task. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

In an example, an AI prompt is a natural language prompt. A natural language prompt is a prompt that is written in a natural language. A natural language is a human language that has developed through use and repetition. In an example, the natural language has developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

In another example, an AI prompt is not written in a natural language. In an implementation of this example, the AI prompt includes (e.g., is) computer code. The AI prompt may be any suitable sequence of characters that is capable of being interpreted by an AI model.

An API input is an AI input that is provided via an API to request a service or a function. An API is an interface between a computing system and code (e.g., software or firmware).

Example embodiments described herein are capable of causing an AI-based runtime issue root cause determination to be performed by providing a tool to an AI model. In an aspect, providing the tool to the AI model enables the AI model to dynamically gather application information at runtime of an application. Application information is information regarding an application. In an example, the application information includes an application model of the application, log(s) associated with the application, and/or application telemetry associated with the application. In another example, the application information covers any number of distinct resources (e.g., services or components) that make up the application. In another aspect, providing the tool to the AI model enables the AI model to perform a test on an application (e.g., to test a hypothesis). In an example of this aspect, the AI model determines that a bug in an application is caused by multiple actions happening simultaneously. In accordance with this example, the AI model uses the tool to run the actions simultaneously. In further accordance with this example, the AI model may execute another tool to review logs that include results of running the actions at the same time.

Example techniques described herein have a variety of benefits as compared to conventional techniques for debugging an application. For instance, the example techniques are capable of determining a root cause of a runtime issue, which is encountered by an application, more accurately, precisely, quickly, efficiently, and/or reliably than the conventional techniques. In an aspect, the example techniques are capable of increasing a statistical accuracy and/or a statistical precision with which the root cause is determined, as compared to the conventional techniques. The example techniques are capable of resolving (e.g., eliminating) the runtime issue more completely, quickly, efficiently, and/or reliably than the conventional techniques. The AI model is capable of analyzing much more data than a human. For instance, the AI model can analyze thousands of records in seconds to find patterns or links. The AI model has a substantial amount of built-in knowledge that the AI model is capable of using during its analysis. For instance, the AI model may be capable of knowing a meaning of a numeric internal error code that may be found in data.

The example techniques are capable of reducing an amount of time and/or resources (e.g., processor cycles, memory, network bandwidth) that is consumed by a computing system to determine a root cause of a runtime issue encountered by an application and/or to resolve the runtime issue. In a first aspect, by receiving a user input via a user interface in an application development environment, the user input inquiring about a root cause of a runtime issue encountered by an application that is under development; determining a particular subset of a plurality of data items regarding the application as a result of the particular subset being relevant to the runtime issue, the particular subset being a first subset of the plurality of data items that defines an application model that includes definitions and runtime information regarding a plurality of resources that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application; causing an AI model to determine the root cause of the runtime issue by providing an AI input together with contextual information to the AI model, the AI input requesting a determination of the root cause of the runtime issue and indicating a tool that is configured to dynamically gather identified data items in the particular subset of the plurality of data items from at least a subset of the plurality of resources while the application is executing, the contextual information including a description of the tool, wherein the description of the tool being included in the contextual information enables the AI model to determine the root cause of the runtime issue by using the tool to dynamically gather the identified data items from at least the subset of the plurality of resources while the application is executing; receiving an AI response from the AI model in response to the AI input, the AI response indicating the root cause of the runtime issue; and/or in response to the user input, providing an indication of the root cause of the runtime issue via the user interface, the example techniques reduce the amount of time and/or resources that is consumed to determine the root cause and/or to resolve the runtime issue.

In a second aspect, by receiving a user input via a user interface in an application development environment, the user input inquiring whether an application that is under development has a runtime issue; determining a particular subset of a plurality of data items that has a relevance to a determination whether the application has the runtime issue that satisfies a relevance criterion, the particular subset being a first subset of the plurality of data items that defines an application model that includes definitions and runtime information regarding a plurality of resources that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application; causing an AI model to determine that the application has the runtime issue and to determine a root cause of the runtime issue by providing an AI input together with contextual information to the AI model, the AI input requesting a determination of whether the application has the runtime issue and indicating a tool that is configured to dynamically gather identified data items in the particular subset of the plurality of data items from at least a subset of the plurality of resources while the application is executing, the contextual information including a description of the tool, wherein the description of the tool being included in the contextual information enables the AI model to determine the root cause of the runtime issue by using the tool to dynamically gather the identified data items from at least the subset of the plurality of resources while the application is executing; receiving an AI response from the AI model in response to the AI input, the AI response indicating that the application has the runtime issue and further indicating the root cause of the runtime issue; and/or in response to the user input, providing a first indication that the application has the runtime issue and a second indication of the root cause of the runtime issue via the user interface, the example techniques reduce the amount of time and/or resources that is consumed to determine the root cause and/or to resolve the runtime issue.

In a third aspect, by determining a particular subset of a plurality of data items that has a relevance to a determination whether an application that is under development has a runtime issue that satisfies a relevance criterion, the particular subset being a first subset of the plurality of data items that defines an application model that includes definitions and runtime information regarding a plurality of resources that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application; in response to detection of a triggering event, causing an AI model to determine that the application has the runtime issue and to determine a root cause of the runtime issue by providing an AI input together with contextual information to the AI model, the AI input requesting a determination of whether the application has the runtime issue and indicating a tool that is configured to dynamically gather identified data items in the particular subset of the plurality of data items from at least a subset of the plurality of resources while the application is executing, the contextual information including a description of the tool, wherein the description of the tool being included in the contextual information enables the AI model to determine the root cause of the runtime issue by using the tool to dynamically gather the identified data items from at least the subset of the plurality of resources while the application is executing; receiving an AI response from the AI model in response to the AI input, the AI response indicating that the application has the runtime issue and further indicating the root cause of the runtime issue; and/or as a result of the AI response indicating that the application has the runtime issue and further indicating the root cause of the runtime issue, performing an action with regard to the runtime issue, the example techniques reduce the amount of time and/or resources that is consumed to determine the root cause and/or to resolve the runtime issue.

In an example implementation, the example techniques automate determining a root cause of a runtime issue encountered by an application and/or resolving the runtime issue. For instance, the example techniques may automate any one or more of the operations described above with regard to the first and/or second aspects. In another example implementation, by reducing the amount of time and/or resources that is consumed by a computing system to determine a root cause of a runtime issue encountered by an application and/or to resolve the runtime issue, the efficiency of the computing system is increased. In yet another example implementation, by reducing the amount of time and/or resources that is consumed by a computing system to determine a root cause of a runtime issue encountered by an application and/or to resolve the runtime issue, a cost associated with determining the root cause and/or resolving the runtime issue is reduced. The example techniques may reduce a loss of revenue caused by the runtime issue. In an example, the runtime issue prevents purchases on a designated website, which results in an organization associated with the application losing $1 million per hour. By increasing a speed with which the root cause of the runtime issue is discovered and/or a speed with which the runtime issue is resolved, the amount of money lost by the organization may be reduced.

In an aspect, by reducing the amount of time that is consumed to determine a root cause of a runtime issue encountered by an application and/or to resolve the runtime issue, the example techniques increase a user experience and/or efficiency of a developer of the application. The example techniques may reduce a number of tasks that are manually performed by the developer by utilizing artificial intelligence and/or by automating determination of the root cause and/or resolution of the runtime issue. By reducing the number of tasks that are manually performed by the developer, a cost associated with tasks that the developer would otherwise perform may be reduced. The example techniques may find the runtime issue more quickly and implement a fix in the appropriate location in the application, which may increase quality of the developer's work and the application.

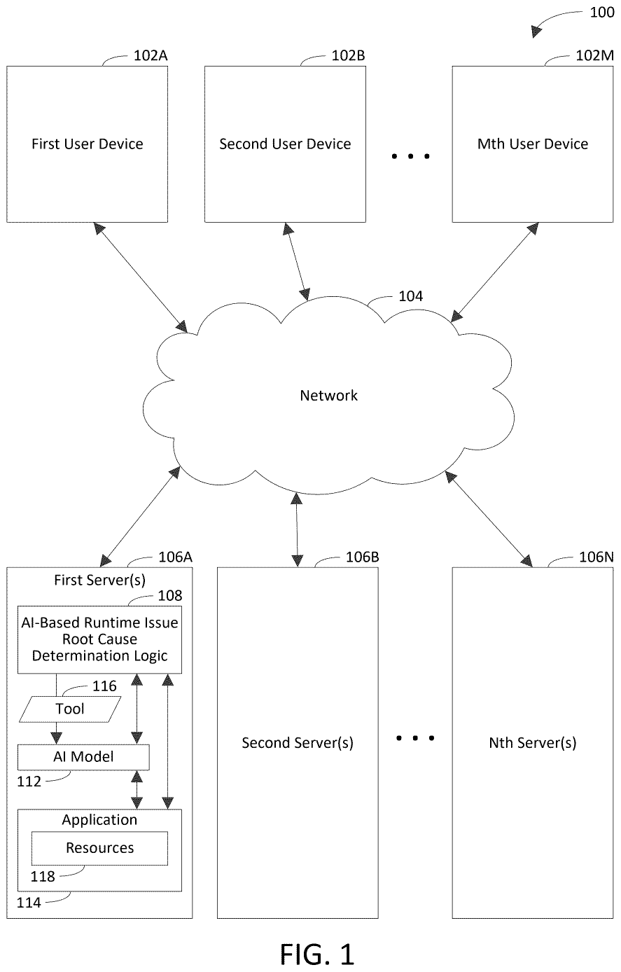

FIG. 1 is a block diagram of an example AI-based runtime issue root cause determination system 100 in accordance with an embodiment. Generally speaking, the AI-based runtime issue root cause determination system 100 operates to provide information to users in response to requests (e.g., hypertext transfer protocol (HTTP) requests) that are received from the users. In an aspect, the information includes documents (Web pages, images, audio files, video files, etc.), output of executables, and/or any other suitable type of information. In accordance with example embodiments described herein, the AI-based runtime issue root cause determination system 100 causes an AI-based runtime issue root cause determination to be performed by providing a tool 116 to an AI model 112, which enables the AI model 112 to dynamically gather application information at runtime of an application 114. Detail regarding techniques for causing an AI-based runtime issue root cause determination to be performed by providing a tool to an AI model, which enables the AI model to dynamically gather application information at runtime of an application, is provided in the following discussion.

As shown in FIG. 1, the AI-based runtime issue root cause determination system 100 includes a plurality of user devices 102A-102M, a network 104, and a plurality of servers 106A-106N. Communication among the user devices 102A-102M and the servers 106A-106N is carried out over the network 104 using well-known network communication protocols. In an aspect, the network 104 is a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors. In an example, the one or more processors are on a same (e.g., single) device. In another example, the one or more processors are distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. In an example, a user initiates a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M are able to access information that is available via the domains. In an aspect, the domains include Web page(s). In an example, the Web page(s) are provided as hypertext markup language (HTML) documents and objects (e.g., files) that are linked therein.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. In an example, the information includes documents (Web pages, images, audio files, video files, etc.), output of executables, or any other suitable type of information. In accordance with some example embodiments, the servers 106A-106N are configured to host respective Web sites, so that the Web sites are accessible to users of the AI-based runtime issue root cause determination system 100.

One example type of computer program that may be executed by one or more of the servers 106A-106N or by any of the user devices 102A-102M is a developer tool. A developer tool is a computer program that performs diagnostic operations (e.g., identifying source of problem, debugging, profiling, controlling, etc.) with respect to program code. Examples of a developer tool include but are not limited to an artificial intelligence (AI) service suite, an integrated development environment (IDE), and a web development platform.

An AI service suite is a program that provides tools that are usable by software developers to build, deploy, and scale AI applications (e.g., AI models). In an aspect, the AI service suite enables the software developers to build, deploy, and/or scale AI application(s) without needing to have extensive AI or data science expertise. An example of an AI service suite is an Azure AI Cloud™ suite, developed distributed by Microsoft Corporation.

An integrated development environment (IDE) is a program that provides tools that are usable by software developers to develop software. In an aspect, the IDE includes a source code editor, build automation tool(s), a debugger, a compiler, and/or an interpreter. Examples of an IDE include but are not limited to a Microsoft Visual Studio® IDE, developed and distributed by Microsoft Corporation; an AppCode® IDE, a PhpStorm® IDE, a Rider® IDE, a WebStorm® IDE, etc., developed and distributed by JetBrains s.r.o.; a JDeveloper® IDE, developed and distributed by Oracle International Corporation; a NetBeans® IDE, developed and distributed by Sun Microsystems, Inc.; an Eclipse™ IDE, developed and distributed by Eclipse Foundation; and an Android Studio™ IDE, developed and distributed by Google LLC and JetBrains s.r.o.

A web development platform is a program that provides tools that are usable by software developers to create, deploy, and manage web applications. In an aspect, the tools perform functions such as web hosting, database management, and/or content delivery. Examples of a web development platform include but are not limited to a Windows Azure® platform, developed and distributed by Microsoft Corporation; an Amazon Web Services® platform, developed and distributed by Amazon.com, Inc.; a Google App Engine® platform, developed and distributed by Google LLC; a VMWare® platform, developed and distributed by VMWare, Inc.; and a Force.com® platform, developed and distributed by Salesforce, Inc.

It will be recognized that the example techniques described herein may be implemented using a developer tool.

In an aspect, a developer tool is incorporated into a cloud computing program (e.g., a cloud service). A cloud computing program is a computer program that provides hosted service(s) via a network (e.g., network 104). In an example, the hosted service(s) are hosted by any one or more of the servers 106A-106N. In another example, the cloud computing program enables users (e.g., at any of the user systems 102A-102M) to access shared resources that are stored on or are otherwise accessible to the server(s) via the network.

In an example of this aspect, the cloud computing program provides hosted service(s) according to a service model. Examples of a service model include but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). In an example, IaaS provides to the user virtualized computing resources that utilize the IaaS provider's physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon.com, Inc.; a Salesforce® program developed and distributed by Salesforce.com, Inc.; an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. In an aspect, one or more of the example techniques described herein are implemented using a cloud computing program. In an example, a software product (e.g., a subscription service, a non-subscription service, or a combination thereof) includes the cloud computing program, and the software product is configured to perform the example techniques.

The first server(s) 106A are shown to include AI-based runtime issue root cause determination logic 108, the AI model 112, and the application 114 for illustrative purposes. The application is defined by a plurality of resources 118. The AI-based runtime issue root cause determination logic 108 is configured to cause an AI-based runtime issue root cause determination to be performed by providing the tool 116 to the AI model 112, which enables the AI model 112 to dynamically gather application information at runtime of the application 114. In a first example implementation, the AI-based runtime issue root cause determination logic 108 receives a user input via a user interface in an application development environment. The user input inquires about a root cause of a runtime issue encountered by an application that is under development. The AI-based runtime issue root cause determination logic 108 determines a particular subset of a plurality of data items regarding the application as a result of the particular subset being relevant to the runtime issue. The particular subset is a first subset of the plurality of data items that defines an application model that includes definitions and runtime information regarding the plurality of resources 118, a second subset of the plurality of data items that includes a resource log that indicates at least one of an event or an error that occurs with regard to the plurality of resources 118, or a third subset of the plurality of data items that includes application telemetry that indicates at least one of performance or usage of the application. The AI-based runtime issue root cause determination logic 108 causes an AI model to determine the root cause of the runtime issue by providing an AI input together with contextual information to the AI model. The AI input requests a determination of the root cause of the runtime issue. The AI input indicates a tool that is configured to dynamically gather identified data items in the particular subset of the plurality of data items from at least a subset of the plurality of resources 118 while the application 114 is executing. The contextual information includes a description of the tool. The description of the tool being included in the contextual information enables the AI model to determine the root cause of the runtime issue by using the tool to dynamically gather the identified data items from at least the subset of the plurality of resources 118 while the application 114 is executing. The AI-based runtime issue root cause determination logic 108 receives an AI response from the AI model in response to the AI input. The AI response indicates the root cause of the runtime issue. In response to the user input, the AI-based runtime issue root cause determination logic 108 provides an indication of the root cause of the runtime issue via the user interface.

In a second example implementation, the AI-based runtime issue root cause determination logic 108 receives a user input via a user interface in an application development environment. The user input inquires whether an application that is under development has a runtime issue. The AI-based runtime issue root cause determination logic 108 determines a particular subset of a plurality of data items that has a relevance to a determination whether the application has the runtime issue that satisfies a relevance criterion. The particular subset is a first subset of the plurality of data items that defines an application model that includes definitions and runtime information regarding the plurality of resources 118, a second subset of the plurality of data items that includes a resource log that indicates at least one of an event or an error that occurs with regard to the plurality of resources 118, or a third subset of the plurality of data items that includes application telemetry that indicates at least one of performance or usage of the application. The AI-based runtime issue root cause determination logic 108 causes an AI model to determine that the application has the runtime issue and to determine a root cause of the runtime issue by providing an AI input together with contextual information to the AI model. The AI input requests a determination of whether the application has the runtime issue and indicating a tool that is configured to dynamically gather identified data items in the particular subset of the plurality of data items from at least a subset of the plurality of resources 118 while the application 114 is executing. The contextual information includes a description of the tool. The description of the tool being included in the contextual information enables the AI model to determine the root cause of the runtime issue by using the tool to dynamically gather the identified data items from at least the subset of the plurality of resources 118 while the application 114 is executing. The AI-based runtime issue root cause determination logic 108 receives an AI response from the AI model in response to the AI input. The AI response indicates that the application has the runtime issue and further indicates the root cause of the runtime issue. In response to the user input, the AI-based runtime issue root cause determination logic 108 provides a first indication that the application has the runtime issue and a second indication of the root cause of the runtime issue via the user interface.

In a third example implementation, the AI-based runtime issue root cause determination logic 108 determines a particular subset of a plurality of data items that has a relevance to a determination whether an application that is under development has a runtime issue that satisfies a relevance criterion. The particular subset is a first subset of the plurality of data items, a second subset of the plurality of data items, or a third subset of the plurality of data items. The first subset defines an application model that includes definitions and runtime information regarding a plurality of resources that define the application. The second subset includes a resource log that indicates an event and/or an error that occurs with regard to the plurality of resources. The third subset includes application telemetry that indicates performance and/or usage of the application. In response to detection of a triggering event, the AI-based runtime issue root cause determination logic 108 causes an AI model to determine that the application has the runtime issue and to determine a root cause of the runtime issue by providing an AI input together with contextual information to the AI model. The AI input requests a determination of whether the application has the runtime issue and indicates a tool that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. The AI-based runtime issue root cause determination logic 108 receives an AI response from the AI model in response to the AI input. The AI response indicates that the application has the runtime issue and further indicates the root cause of the runtime issue. As a result of the AI response indicating that the application has the runtime issue and further indicating the root cause of the runtime issue, the AI-based runtime issue root cause determination logic 108 performs an action with regard to the runtime issue.

The AI-based runtime issue root cause determination logic 108 may be implemented in various ways to cause an AI-based runtime issue root cause determination to be performed by providing a tool to gather application information at runtime of an application, including being implemented in hardware, software, firmware, or any combination thereof. In an aspect, the AI-based runtime issue root cause determination logic 108 is implemented as computer program code configured to be executed in one or more processors. In another aspect, at least a portion of the AI-based runtime issue root cause determination logic 108 is implemented as hardware logic/electrical circuitry. In an example of this aspect, at least a portion of the AI-based runtime issue root cause determination logic 108 is implemented in a field-programmable gate array (FPGA), an application-specific integrated circuit (ASIC), an application-specific standard product (ASSP), a system-on-a-chip system (SoC), and/or a complex programmable logic device (CPLD). In an example, each SoC includes an integrated circuit chip that includes one or more of a processor (a microcontroller, microprocessor, digital signal processor (DSP), etc.), memory, one or more communication interfaces, and/or further circuits and/or embedded firmware to perform its functions.

In an aspect, the AI-based runtime issue root cause determination logic 108 is (or is included in) a developer tool and/or a cloud computing program.

The AI-based runtime issue root cause determination logic 108, the AI model 112, and the application 114 are shown to be incorporated in the first server(s) 106A for illustrative purposes and are not intended to be limiting. It will be recognized that the AI-based runtime issue root cause determination logic 108, the AI model 112, and/or the application 114 (or any portion(s) thereof) may be incorporated in any one or more of the servers 106A-106N, any one or more of the user devices 102A-102M, or any combination thereof. In an example, client-side aspects of the AI-based runtime issue root cause determination logic 108, the AI model 112, and/or the application 114 are incorporated in one or more of the user devices 102A-102M, and server-side aspects of the AI-based runtime issue root cause determination logic 108, the AI model 112, and/or the application 114 are incorporated in one or more of the servers 106A-106N. It will be recognized that the AI-based runtime issue root cause determination logic 108, the AI model 112, and the tool 116 need not necessarily be on a same server as the application 114 and the resources 118. In an example, the application 114 executes on a machine that is different from the machine(s) on which the AI-based runtime issue root cause determination logic 108, the AI model 112, and the tool 116 execute.

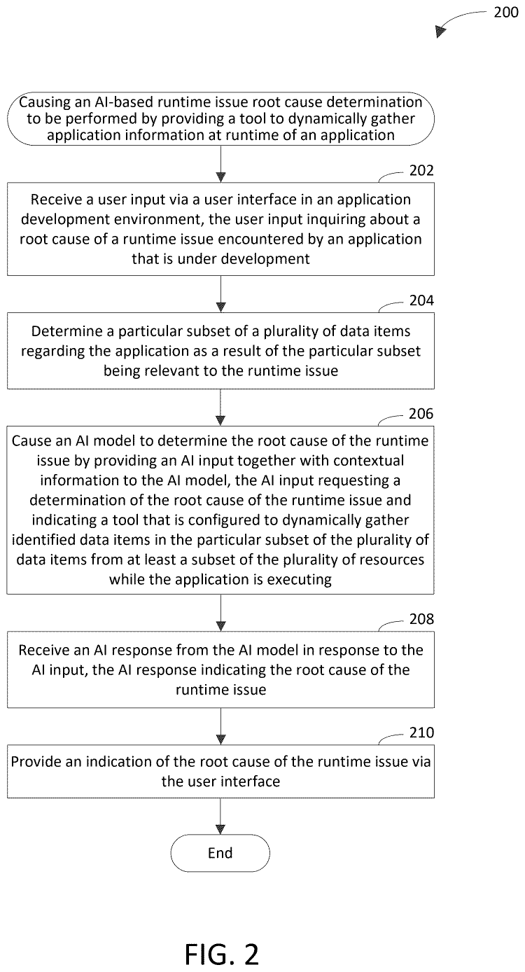

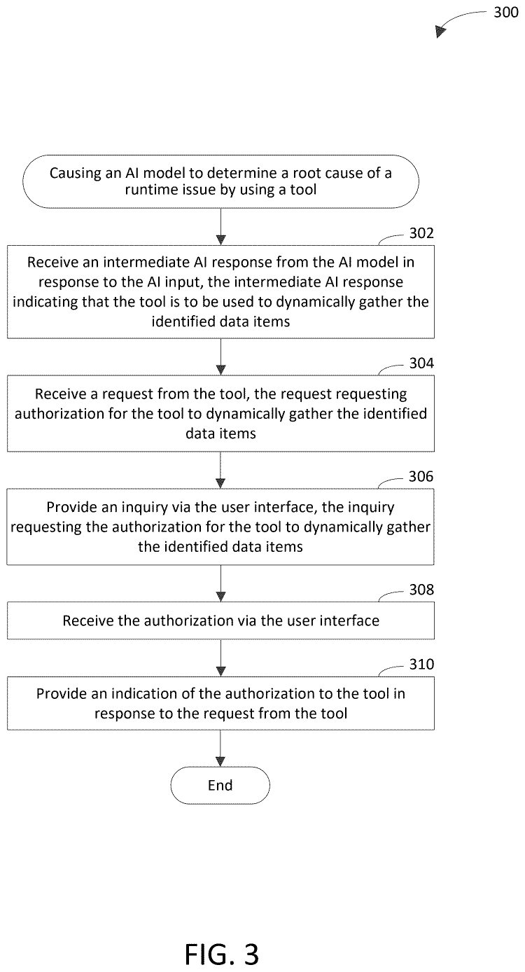

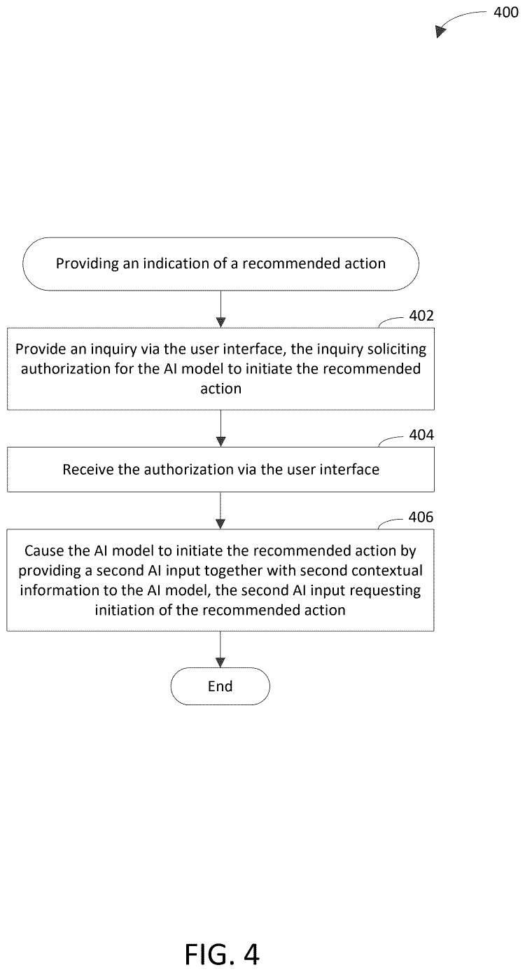

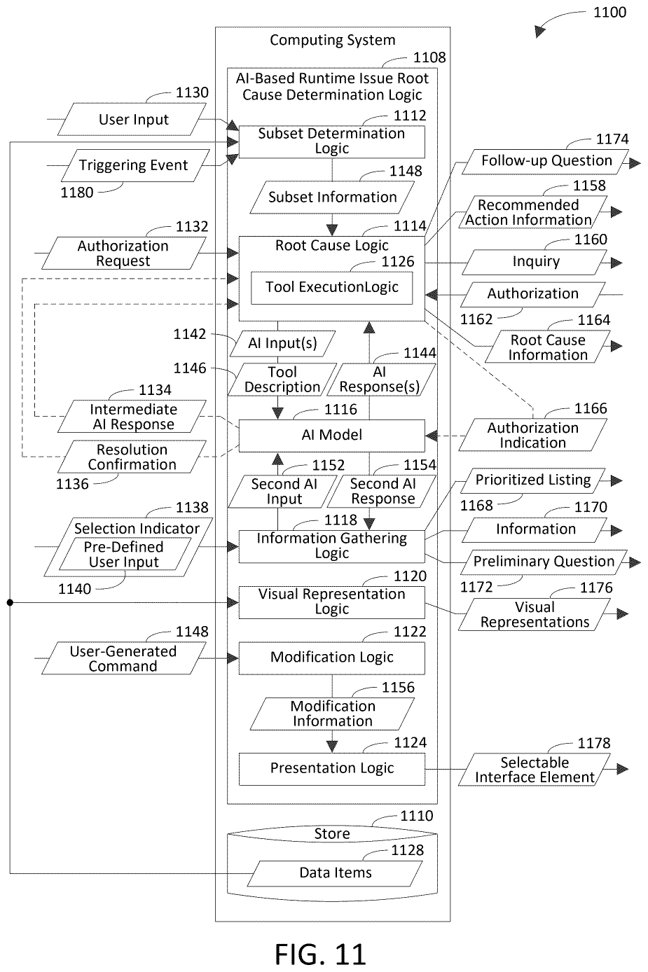

FIGS. 2 and 5-10 depict flowcharts 200, 500, 600, 700, 800, 900, and 1000 of example methods for causing an AI-based runtime issue root cause determination to be performed by providing a tool to dynamically gather application information at runtime of an application in accordance with embodiments. FIG. 3 depicts a flowchart 300 of an example method for causing an AI model to determine a root cause of a runtime issue by using a tool in accordance with an embodiment. FIG. 4 depicts a flowchart 400 of an example method for providing an indication of a recommended action in accordance with an embodiment. Flowcharts 200, 300, 400, 500, 600, 700, 800, 900, and 1000 may be performed by the first server(s) 106A shown in FIG. 1, for example. For illustrative purposes, flowcharts 200, 300, 400, 500, 600, 700, 800, 900, and 1000 are described with respect to a computing system 1100 shown in FIG. 11, which is an example implementation of the first server(s) 106A. As shown in FIG. 11, the computing system 1100 includes AI-based runtime issue root cause determination logic 1108 and a store 1110. The AI-based runtime issue root cause determination logic 1108 includes subset determination logic 1112, root cause logic 1114, an AI model 1116, information gathering logic 1118, visual representation logic 1120, modification logic 1122, and presentation logic 1124. The root cause logic 1114 includes tool execution logic 1126. The store 1110 may be any suitable type of store. One type of store is a database. Examples of a database include but are not limited to a relational database, an entity-relationship database, an object database, an object relational database, and an extensible markup language (XML) database. The store 1110 is shown to store data items 1128 for non-limiting, illustrative purposes. Further structural and operational embodiments will be apparent to persons skilled in the relevant art(s) based on the discussion regarding flowcharts 200, 500, 600, 700, 800, 900, and 1000.

As shown in FIG. 2, the method of flowchart 200 begins at step 202. In step 202, a user input is received via a user interface in an application development environment. In an aspect, the user interface is included in a web tool. A web tool is an online application (e.g., service) that assists a developer in performing tasks such as coding, debugging, testing, and/or project management. The user input inquires about a root cause of a runtime issue encountered by an application that is under development. In an aspect, the runtime issue being encountered by the application triggers presentation of the user interface. In another aspect, the user interface is a dashboard. A dashboard is a user interface that provides a centralized view of tools, metrics, and information related to development of an application.

In an aspect, the runtime issue is a runtime error. A runtime error is a runtime issue that occurs while an application is running and causes the application to become non-operational or to behave unexpectedly. Examples of a runtime error include but are not limited to division by zero, a null pointer dereference, an out-of-bound array access, improper configuration of an application (e.g., resulting in a failure of the application), an authentication error, an authorization error, and a service unexpectedly terminating or freezing. In another aspect, the runtime issue is a performance bottleneck. A performance bottleneck is a runtime issue that causes an application to run at a slower rate (e.g., speed) than expected. In an example, the performance bottleneck delays performance of operation(s) by the application. In yet another aspect, the runtime issue is a concurrency issue. A concurrency issue is a runtime issue resulting from inadequate (e.g., misaligned) synchronization of multiple threads or processes. Examples of a concurrency issue include but are not limited to a race condition, a deadlock, starvation, and resource contention. A race condition is a concurrency issue in which multiple threads or processes access shared resource(s) without adequate synchronization. The race condition may cause the application to provide an unpredictable result. A deadlock is a concurrency issue in which multiple threads wait indefinitely for each other to release resource(s). The deadlock may cause the application to freeze. Starvation is a concurrency issue in which a thread or process is perpetually denied necessary resource(s). The starvation may inhibit (e.g., prevent) the application from making progress with regard to completion of its task. Resource contention is a concurrency issue in which multiple threads or processes compete for the same resource(s). The resource contention may result in a degradation in performance (e.g., efficiency or speed) of the application. In still another aspect, the runtime issue is a memory leak. A memory leak is a runtime issue in which an application fails to release memory. For instance, failing to release the memory may increase an amount of memory that is consumed by the application over time.

In an example implementation, the subset determination logic 1112 receives a user input 1130 via the user interface in the application development environment. The user input 1130 inquires about the root cause of the runtime issue encountered by the application.

At step 204, a particular subset of a plurality of data items regarding the application is determined as a result of the particular subset being relevant to the runtime issue. The particular subset is a first subset of the plurality of data items that defines an application model that includes definitions and runtime information regarding a plurality of resources that define the application, a second subset of the plurality of data items that includes a resource log that indicates an event and/or an error that occurs with regard to the plurality of resources, or a third subset of the plurality of data items that includes application telemetry that indicates performance and/or usage of the application. Resources that define an application are elements (e.g., components or items) that the application uses or consumes during execution of the application. In an aspect, each resource of the application is an executable file or a storage. Examples of a resource of an application include but are not limited to a database, a cache, a container, a frontend (e.g., a website), and a backend. A frontend of an application is a portion of the application with which a user of the application interacts (e.g., directly interacts). In an example, the frontend includes a user interface and/or client-side functionality of the application. A backend of an application manages data processing and storage with regard to the application. In an example, the backend includes server-side functionality of the application. In an example, a definition of a resource includes (e.g., is) code (e.g., source code) that defines the resource.

In an example implementation, the subset determination logic 1112 determines a particular subset of the data items 1128 regarding the application as a result of the particular subset being relevant to the runtime issue. In accordance with this implementation, the particular subset is a first subset of the data items 1128, which defines the application model, a second subset of the data items 1128, which includes the resource log, or a third subset of the data items 1128, which includes the application telemetry. The subset determination logic 1112 generates subset information 1148 to indicate (e.g., specify, identify, or describe) the particular subset of the data items 1128.

At step 206, an AI model is caused to determine the root cause of the runtime issue by providing an AI input together with contextual information to the AI model. The AI input requests a determination of the root cause of the runtime issue and indicates a tool that is configured to dynamically gather identified data items in the particular subset of the plurality of data items from at least a subset of the plurality of resources while the application is executing. The contextual information includes context regarding the AI input. The contextual information includes a description of the tool. In an aspect, the description of the tool includes (e.g., is) a name of the tool, a location at which the tool is stored, an indication that the tool is capable of gathering the identified data items, and/or an indication of a scenario in which the tool is to be used. The description of the tool being included in the contextual information enables the AI model to determine the root cause of the runtime issue by using the tool to dynamically gather the identified data items from at least the subset of the plurality of resources while the application is executing. In another aspect, the contextual information further includes first data items in the first subset of the plurality of data items, second data items in the second subset of the plurality of data items, and/or third data items in the third subset of the plurality of data items. In yet another aspect, causing the AI model to determine the root cause at step 206 includes causing the AI model to analyze the plurality of resources using the tool while the plurality of resources are executing.

The root cause of the runtime issue may be a defect in code that is included in the application, a defect in code that is external to the application and accessed directly or indirectly by the application, corrupted data, a misconfigured component, a defect in a hardware component utilized by the application, and so on. In an aspect, the root cause of the runtime issue is particular code that is included in the application. In an example of this aspect, the particular code is a particular code snippet (e.g., sub-routine) in the application. In another example of this aspect, the particular code is a particular line of code in the application. In another aspect, the root cause of the runtime issue is a dependency that is accessed by the application or a dependency that is accessed through (e.g., by) another dependency that is accessed by the application. Examples of a dependency include but are not limited to a library, a framework, an application programming interface (API), a database, a package, a configuration file, and a third-party service.

In an example implementation, the root cause logic 1114 causes the AI model 1116 to determine the root cause of the runtime issue by providing the AI input, which included in AI input(s) 1142, together with the contextual information to the AI model 1116. In accordance with this implementation, the AI input requests a determination of the root cause of the runtime issue and indicates a tool that is configured to dynamically gather identified data items in the particular subset of the data items 1128 from at least the subset of the plurality of resources while the application is executing. In an aspect, the tool execution logic 1126 and/or the AI model 1116 selects the tool from a plurality of available tools, which are capable of being used by the AI model 1116, as a result of determining that the tool is relevant to determining the root cause of the runtime issue. In accordance with this aspect, the tool execution logic 1126 and/or the AI model 1116 analyzes attributes of the plurality of available tools in context of the runtime issue to determine that the tool is relevant to determining the root cause of the runtime issue. In an example of this aspect, the tool execution logic 1126 and/or the AI model 1116 selects the tool as a result of determining that attributes of the tool correspond to attributes of the runtime issue to an extent that is greater than an extent to which attributes of each other tool in the plurality of available tools correspond to the attributes of the runtime issue. In another example of this aspect, the AI model 1116 determines that it needs the console logs for a resource (e.g., frontend resource) in the application to determine the root cause of the runtime issue. In accordance with this aspect, the AI model 1116 sends a result (e.g., “GetConsoleLogs(frontend)”) to the root cause logic 1114 to indicate that the logs for the resource are needed. In further accordance with this example, the root cause logic 1114 matches the result (e.g., the “GetConsoleLogs” name therein) to one of its tools and provides the tool to the AI model 1116. In further accordance with this example, the AI model 1116 executes the tool with the argument “frontend”. In another example of this aspect, the tool execution logic 1126 and/or the AI model 1116 selects which inputs are to be provided to the tool.

In further accordance with this implementation, the contextual information includes a tool description 1146, which describes the tool. The tool description 1146 being included in the contextual information enables the AI model 1116 to determine the root cause of the runtime issue by using the tool to dynamically gather the identified data items from at least the subset of the plurality of resources while the application is executing. In an aspect, the AI model 1116 is included in the computing system 1100, as shown in FIG. 11. In another aspect, the AI model 1116 is external to the computing system 1100. In an example of this aspect, the AI model 1116 runs on a computing system other than the computing system 1100. In another example of this aspect, the AI-based runtime issue root cause determination logic 1108 (e.g., the root cause logic 1114 therein) interacts with the AI model 1116 via a network (e.g., network 104).

At step 208, an AI response is received from the AI model in response to the AI input. The AI response indicates the root cause of the runtime issue. In an aspect, the AI response further indicates how the root cause of the runtime issue was determined. In an example of this aspect, the AI response cites portions of information relied upon to determine the root cause. In accordance with this example, the AI response may include links to the portions of the information. In an example implementation, the root cause logic 1114 receives the AI response, which is included in AI response(s) 1144, from the AI model 1116 in response to the AI input.

At step 210, in response to the user input, an indication of the root cause of the runtime issue is provided via the user interface. In an aspect, references (e.g., links) to data that are used to determine the root cause of the runtime issue are provided along with the indication of the root cause. In an example of this aspect, the references enable a developer of the application to interactively explore the data. In an example implementation, in response to the user input 1130, the root cause logic 1114 provides root cause information 1164, which indicates the root cause of the runtime issue, via the user interface.

In an example IDE embodiment, the user interface is in an integrated development environment that executes on the computing system. In accordance with the IDE embodiment, receiving the user input at step 202 includes receiving the user input at the integrated development environment. In further accordance with the IDE embodiment, determining the particular subset of the plurality of data items at step 204 includes determining, by the integrated development environment, the particular subset of the plurality of data items. In further accordance with the IDE embodiment, causing the AI model to determine the root cause of the runtime issue at step 206 includes causing, by the integrated development environment, the AI model to determine the root cause of the runtime issue. In further accordance with the IDE embodiment, receiving the AI response at step 208 includes receiving the AI response at the integrated development environment.

In an example dashboard embodiment, the user interface is in a dashboard that is external to an integrated development environment that executes on the computing system. In an aspect, the dashboard executes on the computing system. In accordance with the dashboard embodiment, receiving the user input at step 202 includes receiving the user input at the dashboard. In further accordance with the dashboard embodiment, determining the particular subset of the plurality of data items at step 204 includes determining, by the dashboard, the particular subset of the plurality of data items. In further accordance with the dashboard embodiment, causing the AI model to determine the root cause of the runtime issue at step 206 includes causing, by the dashboard, the AI model to determine the root cause of the runtime issue. In further accordance with the dashboard embodiment, receiving the AI response at step 208 includes receiving the AI response at the dashboard.

In some example embodiments, one or more steps 202, 204, 206, 208, and/or 210 of flowchart 200 may not be performed. Moreover, steps in addition to or in lieu of steps 202, 204, 206, 208, and/or 210 may be performed. For instance, in an example authorization embodiment, causing the AI model to determine the root cause of the runtime issue at step 206 includes causing the AI model to determine the root cause of the runtime issue by using the tool to dynamically gather the identified data items from at least the subset of the plurality of resources while the application is executing. In an aspect, causing the AI model to use the tool to dynamically gather the identified data items enables the AI model to determine the root cause of the runtime issue. In an aspect of the authorization embodiment, causing the AI model to determine the root cause of the runtime issue by using the tool includes one or more of the steps shown in flowchart 300 of FIG. 3. As shown in FIG. 3, the method of flowchart 300 begins at step 302. In step 302, an intermediate AI response is received from the AI model in response to the AI input. The intermediate AI response indicates that the tool is to be used to dynamically gather the identified data items. In an example implementation, the root cause logic 1114 receives an intermediate AI response 1134 from the AI model 1116 in response to the AI input. The intermediate AI response 1134 indicates that the tool is to be used to dynamically gather the identified data items.

At step 304, a request is received from the tool. The request requests authorization for the tool to dynamically gather the identified data items. In an example implementation, the root cause logic 1114 receives an authorization request 1132 from the tool. The authorization request 1132 requests authorization for the tool to dynamically gather the identified data items.

At step 306, an inquiry is provided via the user interface. The inquiry requests the authorization for the tool to dynamically gather the identified data items. In an example implementation, the root cause logic 1114 provides an inquiry 1160 via the user interface. The inquiry 1160 requests the authorization for the tool to dynamically gather the identified data items.

At step 308, in response to providing the inquiry, the authorization is received via the user interface. In an example implementation, in response to providing the inquiry, the root cause logic 1114 receives authorization 1162 via the user interface. The authorization 1162 grants the authorization for the tool to dynamically gather the identified data items. In an aspect, the authorization 1162 includes the authorization.

At step 310, in response to receiving the authorization, an indication of the authorization is provided to the tool in response to the request from the tool. In an example implementation, in response to receiving the authorization 1162, the root cause logic 1114 provides an authorization indication 1166 to the tool in response to the authorization request 1132. The authorization indication 1166 indicates that the authorization has been granted.

In accordance with this aspect, the AI response is received from the AI model at step 208 of FIG. 2 further in response to the indication of the authorization being provided to the tool. In an example implementation, the root cause logic 1114 receives the AI response from the AI model 1116 further in response to the authorization indication 1166 being provided to the tool.

In an example recommendation embodiment, the AI response further indicates a recommended action to resolve the runtime issue. In an aspect, the recommended action is configured to resolve the runtime issue. Examples of a recommended action include but are not limited to restarting a database and resetting a state of the application to a reference state (e.g., by running a command against the application). In accordance with the recommendation embodiment, the method of flowchart 200 further includes providing an indication of the recommended action via the user interface. In an example implementation, the root cause logic 1114 provides recommended action information 1158 via the user interface. The recommended action information 1158 includes the indication of the recommended action.

In an aspect of the recommendation embodiment, the method of flowchart 200 includes one or more of the steps shown in flowchart 400 of FIG. 4. As shown in FIG. 4, the method of flowchart 400 begins at step 402. In step 402, an inquiry is provided via the user interface. The inquiry solicits authorization for the AI model to initiate the recommended action. In an example, providing the indication of the recommended action, as described above, includes step 402. In an example implementation, the root cause logic 1114 provides the inquiry 1160 via the user interface. The inquiry 1160 solicits authorization for the AI model 1116 to initiate the recommended action, which is indicated by the recommended action information 1158.

At step 404, the authorization is received via the user interface. In an example, the authorization is received in response to providing the inquiry. In an example implementation, the root cause logic 1114 receives authorization 1162 via the user interface. The authorization 1162 authorizes the AI model 1116 to initiate the recommended action that is indicated by the recommended action information 1158. In an aspect, the root cause logic 1114 receives the authorization 1162 in response to providing the inquiry 1160.

At step 406, in response to receiving the authorization, the AI model is caused to initiate the recommended action by providing a second AI input together with second contextual information to the AI model. The second AI input requests initiation of the recommended action. The second contextual information includes a dialog with the AI model that includes the AI input, the contextual information, and the AI response. In an example, the second contextual information includes context regarding the second AI input. In an example implementation, in response to receiving the authorization 1162, the root cause logic 1114 causes the AI model to initiate the recommended action by providing the second AI input, which is included in the AI input(s) 1142, together with second contextual information to the AI model 1116. In accordance with this implementation, the second contextual information including a dialog with the AI model 1116. The dialog with the AI model 1116 includes the AI input, the contextual information, and the AI response.

In an example of this aspect, the AI model is caused to initiate the recommended action using sample data. For instance, the AI model may process the sample data to determine the recommended action. In an example implementation, the AI model is caused to initiate the recommended action using dynamically created data received from the plurality of resources while the plurality of resources are executing.

In another example of this aspect, the method of flowchart 400 further includes selecting a second tool from a plurality of tools as a result of the second tool being configured to perform the recommended action. In an example implementation, the tool execution logic 1126 selects a second tool from a plurality of tools as a result of the second tool being configured to perform the recommended action. In accordance with this example, the second AI input indicates (e.g., identifies or describes) the second tool. In further accordance with this example, the second contextual information includes a description of the second tool. The description of the second tool being included in the second contextual information enables the AI model to initiate the recommended action using the second tool.

In yet another example of this aspect, the second AI input requests confirmation as to whether performance of the recommended action resolves the runtime issue. In accordance with this example, the method of flowchart 400 further includes, in response to causing the AI model to initiate the recommended action, confirmation is received from the AI model. The confirmation indicates that the runtime issue is resolved. In an example implementation, in response to causing the AI model 1116 to initiate the recommended action, the root cause logic 1114 receives resolution confirmation 1136 from the AI model. The resolution confirmation 1136 indicates that the runtime issue is resolved.

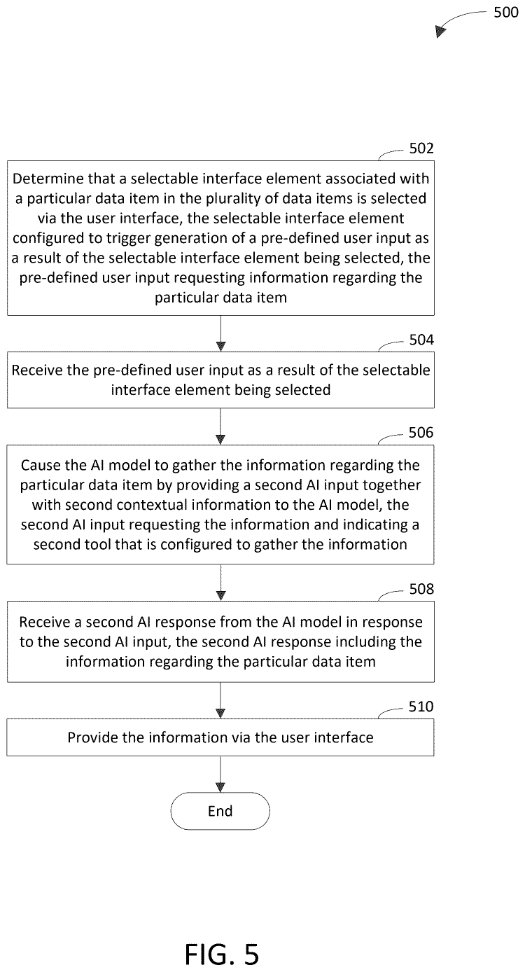

In an example pre-defined user input embodiment, the method of flowchart 200 includes one or more of the steps shown in flowchart 500 of FIG. 5. As shown in FIG. 5, the method of flowchart 500 begins at step 502. In step 502, a determination is made that a selectable interface element associated with a particular data item in the plurality of data items is selected via the user interface. The selectable interface element is configured to trigger generation of a pre-defined user input as a result of the selectable interface element being selected. The pre-defined user input requests information regarding the particular data item. In an example implementation, the information gathering logic 1118 determines that the selectable interface element associated with the particular data item, which is included in the data items 1128, is selected via the user interface. In an aspect, the information gathering logic 1118 determines that the selectable interface element is selected via the user interface as a result of receiving the selection indicator 1138. The selectable interface element is configured to trigger generation of a pre-defined user input 1140 as a result of the selectable interface element being selected. The pre-defined user input 1140 requests information 1170 regarding the particular data item.

At step 504, the pre-defined user input is received as a result of the selectable interface element being selected. In an example implementation, the information gathering logic 1118 receives the pre-defined user input 1140 as a result of the selectable interface element being selected. In an aspect, the selection indicator 1138 includes the pre-defined user input 1140.

At step 506, the AI model is caused to gather the information regarding the particular data item by providing a second AI input together with second contextual information to the AI model. The second AI input requests the information and indicates a second tool that is configured to gather the information. The second contextual information includes a description of the second tool. The description of the second tool being included in the second contextual information enables the AI model to gather the information by using the second tool. In an example implementation, the information gathering logic 1118 causes the AI model 1116 to gather the information 1170 regarding the particular data item by providing a second AI input 1152 together with second contextual information to the AI model 1116. The second AI input 1152 requests the information 1170 and indicates the second tool, which is configured to gather the information 1170. The second contextual information includes the description of the second tool. The description of the second tool being included in the second contextual information enables the AI model 1116 to gather the information 1170 by using the second tool.

At step 508, a second AI response is received from the AI model in response to the second AI input. The second AI response includes the information regarding the particular data item. In an example implementation, the information gathering logic 1118 receives a second AI response 1154 from the AI model 1116 in response to the second AI input 1152. The second AI response 1154 includes the information 1170 regarding the particular data item.

At step 510, in response to the pre-defined user input, the information is provided via the user interface. In an example implementation, in response to the pre-defined user input 1140, the information gathering logic 1118 provides the information 1170 via the user interface.

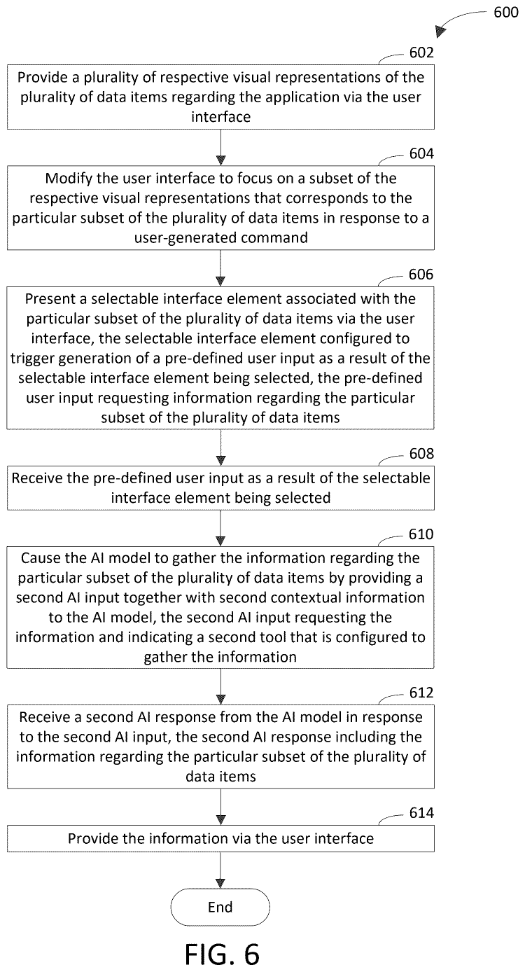

In an example interface focusing embodiment, the method of flowchart 200 includes one or more of the steps shown in flowchart 600 of FIG. 6. As shown in FIG. 6, the method of flowchart 600 begins at step 602. In step 602, a plurality of respective visual representations of the plurality of data items regarding the application are provided via the user interface. In an example implementation, the visual representation logic 1120 provides visual representations 1176 of the respective data items 1128 via the user interface.

At step 604, the user interface is modified to focus on a subset of the respective visual representations that corresponds to the particular subset of the plurality of data items in response to a user-generated command. In an aspect, modifying the user interface at step 604 includes distinguishing the subset of the respective visual representations from other subsets of the respective visual representations that correspond to subsets of the plurality of data items other than the particular subset of the plurality of data items in the user interface. In an example of this aspect, modifying the user interface at step 604 includes highlighting the subset of the respective visual representations in the user interface. In another aspect, modifying the user interface at step 604 includes remove the other subsets of the respective visual representations, which correspond to the subsets of the plurality of data items other than the particular subset of the plurality of data items, from the user interface. In an example implementation, the modification logic 1122 modifies the user interface to focus on a subset of the visual representations 1176 that corresponds to the particular subset of the data items 1128 in response to a user-generated command 1148. The modification logic 1122 generates modification information 1156, which indicates that the user interface is (e.g., has been) modified to focus on the subset of the visual representations 1176 that corresponds to the particular subset of the data items 1128.

At step 606, a selectable interface element associated with the particular subset of the plurality of data items is presented via the user interface as a result of the user interface being modified to focus on the subset of the respective visual representations that corresponds to the particular subset of the plurality of data items. The selectable interface element is configured to trigger generation of a pre-defined user input as a result of the selectable interface element being selected. The pre-defined user input requests information regarding the particular subset of the plurality of data items. In an example implementation, the presentation logic 1124 presents a selectable interface element 1178, which is associated with the particular subset of the data items 1128, via the user interface. The presentation logic 1124 presents the selectable interface element 1178 as a result of the modification information 1156 indicating that the user interface is modified to focus on the subset of the visual representations 1176 that corresponds to the particular subset of the data items 1128. The selectable interface element 1178 is configured to trigger generation of a pre-defined user input 1140 as a result of the selectable interface element 1178 being selected. The pre-defined user input 1140 requests information 1170 regarding the particular subset of the data items 1128.

The pre-defined user input may be programmatically selected from a plurality of pre-defined user-defined inputs based on any of a variety of factors. In an example, an error is detected with regard to the application due to error(s) being indicated by logs. In accordance with this example, the pre-defined user input is programmatically selected based on a determination that a failure is to be diagnosed. In another example, a developer of the application has been spending a substantial amount of time reviewing timeline and trace information. In accordance with this example, the pre-defined user input is programmatically selected as a result of an analysis of the AI model skewing more toward performance-focused investigations based on an inference that the developer is interested in performance of the application. In yet another example, the application information and a list of canned questions are provided to the AI model, which causes the AI model to programmatically select the pre-defined user input form the plurality of pre-defined user-defined inputs.

At step 608, the pre-defined user input is received as a result of the selectable interface element being selected. In an example implementation, the information gathering logic 1118 receives the pre-defined user input 1140 as a result of the selectable interface element 1178 being selected.

At step 610, the AI model is caused to gather the information regarding the particular subset of the plurality of data items by providing a second AI input together with second contextual information to the AI model. The second AI input requests the information and indicates a second tool that is configured to gather the information. The second contextual information includes a description of the second tool. The description of the second tool being included in the second contextual information enables the AI model to gather the information by using the second tool. In an example implementation, the information gather logic 1118 causes the AI model 1116 to gather the information 1170 regarding the particular subset of the data items 1128 by providing a second AI input 11152 together with second contextual information to the AI model 1116. The second AI input 1152 requests the information 1170 and indicates a second tool that is configured to gather the information 1170. The second contextual information includes a description of the second tool. The description of the second tool being included in the second contextual information enables the AI model 1116 to gather the information 1170 by using the second tool.

At step 612, a second AI response is received from the AI model in response to the second AI input. The second AI response includes the information regarding the particular subset of the plurality of data items. In an example implementation, the information gathering logic 1118 receives a second AI response 1154 from the AI model 1116 in response to the second AI input 1152. The second AI response 1154 includes the information 1170 regarding the particular subset of the data items 1128.

At step 614, in response to the pre-defined user input, the information is provided via the user interface. In an example implementation, in response to the pre-defined user input 1140, the information gathering logic 1118 provides the information 1170 via the user interface.

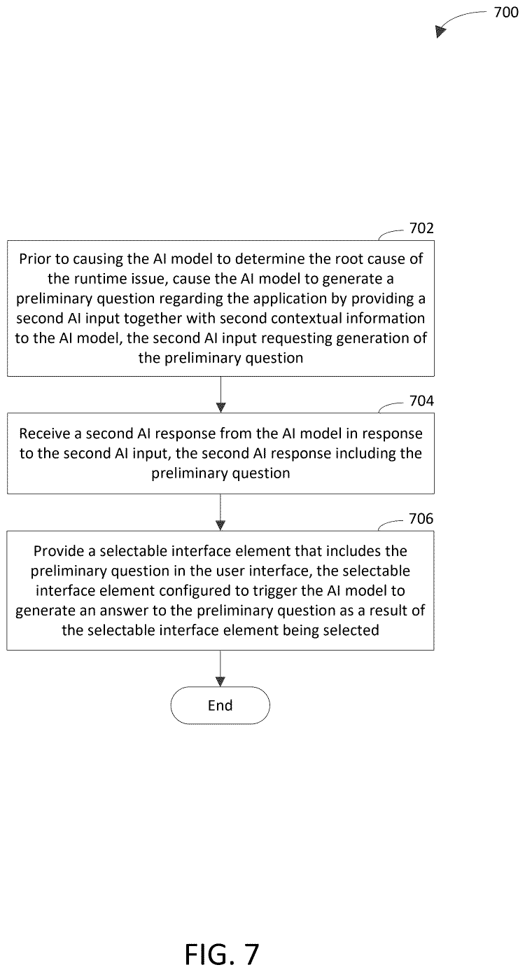

In an example preliminary question embodiment, the method of flowchart 200 includes one or more of the steps shown in flowchart 700 of FIG. 7. As shown in FIG. 7, the method of flowchart 700 begins at step 702. In step 702, prior to causing the AI model to determine the root cause of the runtime issue, the AI model is caused to generate a preliminary question regarding the application by providing a second AI input together with second contextual information to the AI model. The second AI input requests generation of the preliminary question. The second contextual information includes first data items in the first subset of the plurality of data items, second data items in the second subset of the plurality of data items, and/or third data items in the third subset of the plurality of data items. In an aspect, the AI model is automatically caused to generate the preliminary question. In another aspect, the AI model is caused to generate the preliminary question in response to a user-generated command (e.g., user-generated command 1148). For instance, the user-generated command may be a gesture of a user with regard to a data item that is included in the plurality of data items. In an example implementation, prior to causing the AI model 1116 to determine the root cause of the runtime issue, the information gather logic 1118 causes the AI model 1116 to generate a preliminary question 1172 regarding the application by providing a second AI input 1152 together with second contextual information to the AI model 1116. The second AI input 1152 requests generation of the preliminary question 1172. The second contextual information includes first data items in the first subset of the data items 1128, second data items in the second subset of the data items 11128, and/or third data items in the third subset of the data items 1128.

At step 704, a second AI response is received from the AI model in response to the second AI input. The second AI response includes the preliminary question. In an example implementation, the information gathering logic 1118 receives a second AI response 1154 from the AI model 1116 in response to the second AI input 1152. The second AI response 1154 includes the preliminary question 1172.

At step 706, in response to receiving the second AI response, a selectable interface element that includes the preliminary question is provided in the user interface. The selectable interface element is configured to trigger the AI model to generate an answer to the preliminary question as a result of the selectable interface element being selected. In an example implementation, in response to receiving the second AI response 1154, the information gathering logic 1118 provides the selectable interface element (e.g., selectable interface element 1178), which includes the preliminary question 1172, in the user interface. In accordance with this implementation, the selectable interface element is configured to trigger the AI model 1116 to generate an answer to the preliminary question 1172 as a result of the selectable interface element being selected.

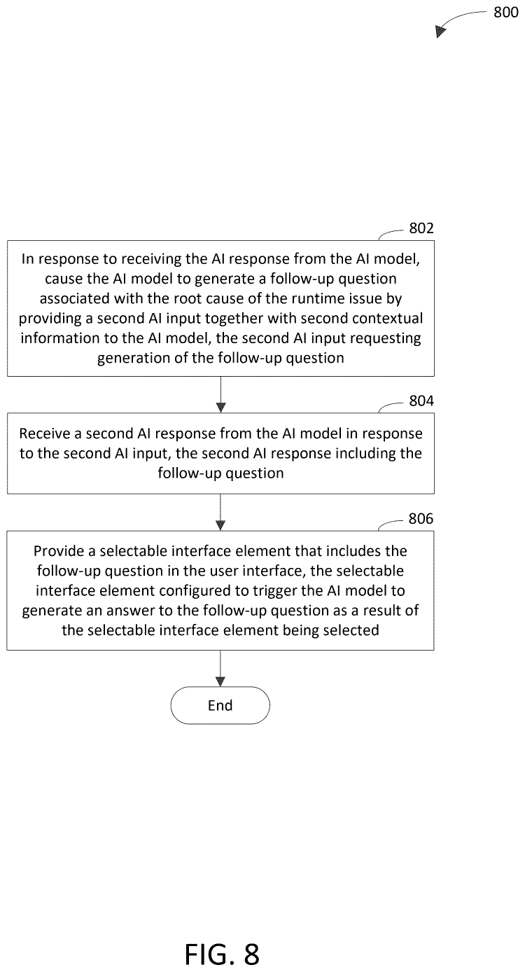

In an example follow-up question embodiment, the method of flowchart 200 includes one or more of the steps shown in flowchart 800 of FIG. 8. As shown in FIG. 8, the method of flowchart 800 begins at step 802. In step 802, in response to receiving the AI response from the AI model, the AI model is caused to generate a follow-up question associated with the root cause of the runtime issue by providing a second AI input together with second contextual information to the AI model. The second AI input requests generation of the follow-up question. The second contextual information includes a dialog with the AI model that includes the AI input, the contextual information, and the AI response. In an aspect, the AI model is automatically caused to generate the follow-up question. In another aspect, the AI model is caused to generate the follow-up question in response to a user-generated command (e.g., user-generated command 1148). In an example implementation, in response to receiving the AI response from the AI model 1116, the root cause logic 1114 causes the AI model 1116 to generate a follow-up question 1174 associated with the root cause of the runtime issue by providing the second AI input, which is included in the AI input(s) 1142, together with second contextual information to the AI model 1116. The second AI input requests generation of the follow-up question 1174. The second contextual information includes a dialog with the AI model 1116 that includes the AI input, the contextual information, and the AI response.

At step 804, a second AI response is received from the AI model in response to the second AI input. The second AI response includes the follow-up question. In an example implementation, the root cause logic 1114 receives the second AI response, which is included in the AI response(s) 1144, from the AI model 1116 in response to the second AI input. In accordance with this implementation, the second AI response includes the follow-up question 1174.

At step 806, in response to receiving the second AI response, a selectable interface element that includes the follow-up question is provided in the user interface. The selectable interface element is configured to trigger the AI model to generate an answer to the follow-up question as a result of the selectable interface element being selected. In an example implementation, in response to receiving the second AI response, the root cause logic 1114 provides the selectable interface element (e.g., selectable interface element 1178), which includes the follow-up question 1174, in the user interface. In accordance with this implementation, the selectable interface element is configured to trigger the AI model 1116 to generate an answer to the follow-up question 1174 as a result of the selectable interface element being selected.

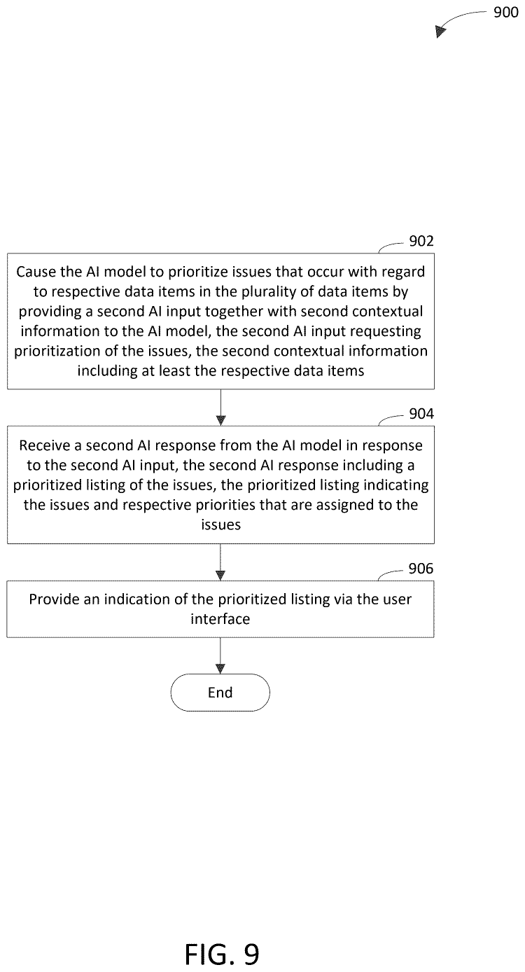

In an example issue prioritization embodiment, the method of flowchart 200 includes one or more of the steps shown in flowchart 900 of FIG. 9. As shown in FIG. 9, the method of flowchart 900 begins at step 902. In step 902, the AI model is caused to prioritize issues that occur with regard to respective data items in the plurality of data items by providing a second AI input together with second contextual information to the AI model. The second AI input requests prioritization of the issues. The second contextual information includes at least the respective data items. In an example implementation, the information gathering logic 1118 causes the AI model 1116 to prioritize the issues that occur with regard to the respective data items in the data items 1128 by providing a second AI input 1152 together with second contextual information to the AI model 1116. The second AI input 1152 requests prioritization of the issues.

At step 904, a second AI response is received from the AI model in response to the second AI input. The second AI response includes a prioritized listing of the issues. The prioritized listing indicates the issues and respective priorities that are assigned to the issues. In an aspect, the respective priorities indicate respective urgencies of the issues. In another aspect, the respective priorities indicate respective importances of the issues. In an example implementation, the information gathering logic 1118 receives a second AI response 1154 from the AI model 1116 in response to the second AI input 1152. The second AI response 1154 includes a prioritized listing 1168 of the issues. The prioritized listing 1168 indicates the issues and the respective priorities that are assigned to the issues.

At step 906, in response to receiving the second AI response, an indication of the prioritized listing is provided via the user interface. In an example implementation, in response to receiving the second AI response 1154, the information gathering logic 1118 provides an indication of the prioritized listing 1168 via the user interface.

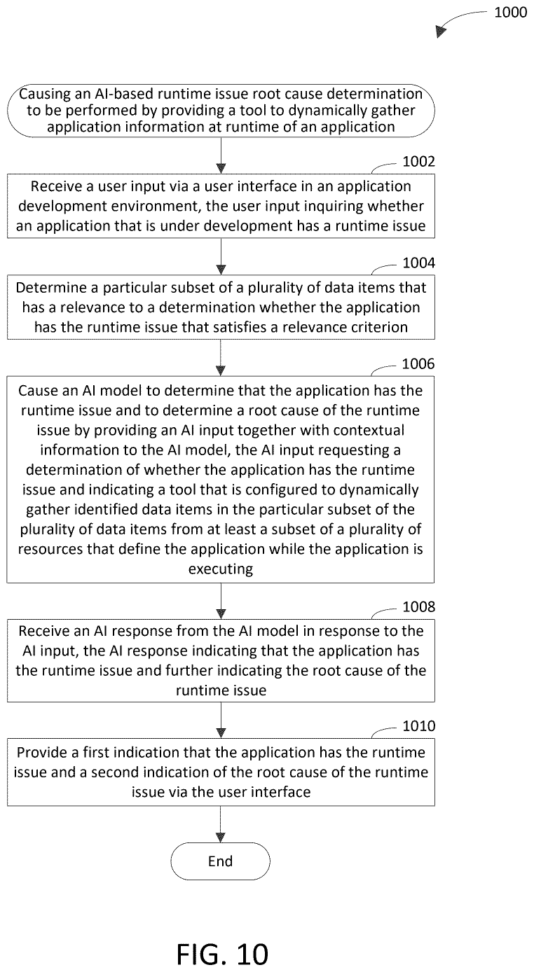

As shown in FIG. 10, the method of flowchart 1000 begins at step 1002. In step 1002, a user input is received via a user interface in an application development environment. The user input inquires whether an application that is under development has a runtime issue. In an example implementation, the subset determination logic 1112 receives a user input 1130 via the user interface in the application development environment. The user input 1130 inquires whether the application that is under development has a runtime issue.

At step 1004, a particular subset of a plurality of data items, which has a relevance that satisfies a relevance criterion, is determined. The relevance is to a determination whether the application has the runtime issue. In an aspect, the relevance indicates an extent to which the particular subset is relevant to the determination whether the application has the runtime issue. In another aspect, relevance criterion requires the relevance to be greater than or equal to a relevance threshold. For instance, the relevance threshold may be 70%, 80%, or 90%. In an example of this aspect, the relevance threshold is a threshold likelihood of relevance. In another example of this aspect, the relevance threshold is a threshold confidence that the particular subset is relevant to the determination whether the application has the runtime issue. The particular subset is a first subset of the plurality of data items, a second subset of the plurality of data items, or a third subset of the plurality of data items. The first subset of the plurality of data items defines an application model that includes definitions and runtime information regarding a plurality of resources that define the application. The second subset of the plurality of data items includes a resource log that indicates an event and/or an error that occurs with regard to the plurality of resources. The third subset of the plurality of data items includes application telemetry that indicates performance and/or usage of the application. In an example implementation, the subset determination logic 1112 determines a particular subset of the data items 1128 that has a relevance that satisfies the relevance criterion. The relevance is to a determination whether the application has the runtime issue. In accordance with this implementation, the particular subset is a first subset of the data items 1128, a second subset of the data items 1128, or a third subset of the data items 1128. The first subset of the data items 1128 defines the application model. The second subset of the data items 1128 includes the resource log. The third subset of the data items 1128 includes the application telemetry. The subset determination logic 1112 generates subset information 1148 to indicate the particular subset of the data items 1128.

At step 1006, an AI model is caused to determine that the application has the runtime issue and to determine a root cause of the runtime issue by providing an AI input together with contextual information to the AI model. The AI input requests a determination of whether the application has the runtime issue. The AI input indicates a tool that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. In an aspect, the contextual information further includes first data items in the first subset of the plurality of data items, second data items in the second subset of the plurality of data items, and/or third data items in the third subset of the plurality of data items.

In an example implementation, the root cause logic 1114 causes the AI model 1116 to determine that the application has the runtime issue and to determine the root cause of the runtime issue by providing the AI input, which is included in the AI input(s) 1142, together with the contextual information to the AI model 1116. In accordance with this implementation, the AI input requests the determination of whether the application has the runtime issue and indicates the tool, which is configured to dynamically gather identified data items in the particular subset of the data items 1128 from at least the subset of the plurality of resources while the application is executing. In an aspect, the tool execution logic 1126 determines the tool by analyzing the subset information. In an example of this aspect, the tool execution logic 1126 determines the tool by matching attributes of the particular subset, as indicated by the subset information 1148, to attributes of the tool. In further accordance with this implementation, the contextual information includes a description of the tool, which enables the AI model to determine the root cause of the runtime issue by using the tool to dynamically gather the identified data items from at least the subset of the plurality of resources while the application is executing.

At step 1008, an AI response is received from the AI model in response to the AI input. The AI response indicates that the application has the runtime issue and further indicates the root cause of the runtime issue. In an example implementation, the root cause logic 1114 receives the AI response, which is included in the AI response(s) 1144, from the AI model 1116 in response to the AI input.

At step 1010, in response to the user input, a first indication that the application has the runtime issue and a second indication of the root cause of the runtime issue are provided via the user interface. In an example implementation, in response to the user input 1130, the root cause logic 1114 provides root cause information 1164 via the user interface. The root cause information 1164 includes the first indication that the application has the runtime issue and the second indication of the root cause of the runtime issue.

In an example IDE embodiment, the user interface is in an integrated development environment that executes on the computing system. In accordance with the IDE embodiment, the user input is received in step 1002 at the integrated development environment. In further accordance with the IDE embodiment, the particular subset of the plurality of data items is determined in step 1004 by the integrated development environment. In further accordance with the IDE embodiment, the AI model is caused to determine that the application has the runtime issue and to determine the root cause of the runtime issue in step 1006 by the integrated development environment. In further accordance with the IDE embodiment, the AI response is received in step 1008 at the integrated development environment.

In an example dashboard embodiment, the user interface is in a dashboard that executes on the computing system. In accordance with the dashboard embodiment, the user input is received in step 1002 at the dashboard. In further accordance with the dashboard embodiment, the particular subset of the plurality of data items is determined in step 1004 by the dashboard. In further accordance with the dashboard embodiment, the AI model is caused to determine that the application has the runtime issue and to determine the root cause of the runtime issue in step 1006 by the dashboard. In further accordance with the dashboard embodiment, the AI response is received in step 1008 at the dashboard.

In some example embodiments, one or more steps 1002, 1004, 1006, 1008, and/or 1010 of flowchart 1000 may not be performed. Moreover, steps in addition to or in lieu of steps 1002, 1004, 1006, 1008, and/or 1010 may be performed. For instance, in an example authorization embodiment, causing the AI model to determine that the application has the runtime issue and to determine the root cause of the runtime issue at step 1006 includes causing the AI model to determine the root cause of the runtime issue by using the tool to dynamically gather the identified data items from at least the subset of the plurality of resources while the application is executing. In an aspect, causing the AI model to use the tool to dynamically gather the identified data items enables the AI model to determine the root cause of the runtime issue. In an aspect of the authorization embodiment, causing the AI model to determine the root cause of the runtime issue by using the tool includes one or more of the steps shown in flowchart 300 of FIG. 3, which is described in further detail above. In accordance with this aspect, at least a portion of the AI response that indicates the root cause of the runtime issue is received from the AI model at step 1008 of FIG. 10 further in response to the indication of the authorization being provided to the tool. In an example implementation, the root cause logic 1114 receives at least a portion of the AI response that indicates the root cause of the runtime issue from the AI model 1116 further in response to the authorization indication 1166 being provided to the tool.

In an example recommendation embodiment, the AI response further indicates a recommended action to resolve the runtime issue. In an aspect, the recommended action is configured to resolve the runtime issue. In accordance with the recommendation embodiment, the method of flowchart 1000 further includes providing an indication of the recommended action via the user interface. In an example implementation, the root cause logic 1114 provides recommended action information 1158 via the user interface. The recommended action information 1158 includes the indication of the recommended action.

In an aspect of the recommendation embodiment, the method of flowchart 1000 includes one or more of the steps shown in flowchart 400 of FIG. 4, which is described in further detail above. In an example of this aspect, the AI model is caused to initiate the recommended action using sample data. For instance, the AI model may process the sample data to determine the recommended action. In an example implementation, the AI model is caused to initiate the recommended action using dynamically created data received from the plurality of resources while the plurality of resources are executing.

In another example of this aspect, the method of flowchart 400 further includes selecting a second tool from a plurality of tools as a result of the second tool being configured to perform the recommended action. In an example implementation, the tool execution logic 1126 selects a second tool from a plurality of tools as a result of the second tool being configured to perform the recommended action. In accordance with this example, the second AI input indicates (e.g., identifies or describes) the second tool. In further accordance with this example, the second contextual information includes a description of the second tool. The description of the second tool being included in the second contextual information enables the AI model to initiate the recommended action using the second tool.

In yet another example of this aspect, the second AI input requests confirmation as to whether performance of the recommended action resolves the runtime issue. In accordance with this example, the method of flowchart 400 further includes, in response to causing the AI model to initiate the recommended action, confirmation is received from the AI model. The confirmation indicates that the runtime issue is resolved. In an example implementation, in response to causing the AI model 1116 to initiate the recommended action, the root cause logic 1114 receives resolution confirmation 1136 from the AI model. The resolution confirmation 1136 indicates that the runtime issue is resolved.

In an example pre-defined user input embodiment, the method of flowchart 1000 includes one or more of the steps shown in flowchart 500 of FIG. 5, which is described in further detail above.

In an example interface focusing embodiment, the method of flowchart 1000 includes one or more of the steps shown in flowchart 600 of FIG. 6, which is described in further detail above.

In an example preliminary question embodiment, the method of flowchart 1000 includes one or more of the steps shown in flowchart 700 of FIG. 7, which is described in further detail above, except with one change. In particular, the AI model is caused to generate the preliminary question at step 702 prior to causing the AI model to determine that the application has the runtime issue (e.g., rather than prior to causing the AI model to determine the root cause of the runtime issue).

In an example follow-up question embodiment, the method of flowchart 1000 includes one or more of the steps shown in flowchart 800 of FIG. 8, which is described in further detail above.

In an example issue prioritization embodiment, the method of flowchart 1000 includes one or more of the steps shown in flowchart 900 of FIG. 9, which is described in further detail above.

In an example autonomous embodiment, a triggering event is detected in lieu of performing step 1002. In an example implementation, the subset determination logic 1112 detects a triggering event 1180. In an aspect, the triggering event is defined by an error being logged by the application. In another aspect, the triggering event is defined by a health check of the application returning a failed result (i.e., a health of the application that is less than or equal to a health threshold). In yet another aspect, the application is checked periodically using a timer to determine whether a runtime issue (e.g., an error) has been encountered by the application. For example, the subset determination logic 1112 may check the application periodically using the timer. In accordance with this aspect, the triggering event is defined by the runtime issue being encountered by the application. In an example of this aspect, the application is checked at intervals having a duration of a designated (e.g., fixed or pre-determined) amount of time. For instance, the designated amount of time may be 5 minutes, 10 minutes, 15 minutes, or 30 minutes. In still another aspect, the triggering event is defined by an AI agent requesting a determination whether the application has a runtime issue.

In an example of the autonomous embodiment, in addition to or in lieu of performing step 1010, an action is performed (e.g., automatically performed) with regard to the runtime issue as a result of the triggering event being detected. In an aspect, the action is performed with regard to the root cause of the runtime issue. In an example implementation, the root cause logic 1114 performs the action. In an aspect, the action includes storing the first indication that the application has the runtime issue and/or the second indication of the root cause of the runtime issue. In an example of this aspect, the first indication and/or the second indication is stored in a file, in a database, in a communication (e.g., an email or a text message), or in persistent memory. For instance, the first indication and/or the second indication may be stored in the store 1110. In another aspect, the action includes causing the AI model to initiate a corrective action that addresses (e.g., resolves or mitigates) the runtime issue by providing a second AI input together with second contextual information to the AI model. In accordance with this aspect, the second AI input requests initiation of the corrective action. In further accordance with this aspect, the second contextual information includes a dialog with the AI model that includes the AI input, the contextual information, and the AI response. In an example of this aspect, the corrective action addresses the root cause of the runtime issue. In an example implementation, the AI input(s) 1142 include the second AI input.

In an example runtime issue embodiment, the root cause logic 1114 causes (e.g., triggers) the AI model 1116 to analyze (e.g., develop and/or refine an understanding of) the AI input(s) 1142, the contextual information (including the tool description 1146), relationships between any of the foregoing, and confidences in those relationships. In an aspect, the root cause logic 1114 causes the AI model 1116 to compare features of the AI input(s) 1142 and the contextual information (including the tool description 1146) using artificial intelligence to determine that an application has a runtime issue and/or to determine a root cause of the runtime issue. In an example, the contextual information further includes sample AI input(s) and sample contextual information (e.g., sample tool descriptions).

In an example recommended action embodiment, the root cause logic 1114 causes (e.g., triggers) the AI model 1116 to analyze (e.g., develop and/or refine an understanding of) the AI input(s) 1142, the contextual information (including the dialog with the AI model 1116 and/or the description of the second tool), relationships between any of the foregoing, and confidences in those relationships. In an aspect, the root cause logic 1114 causes the AI model 1116 to compare features of the AI input(s) 1142 and the contextual information (including the dialog with the AI model 1116 and/or the description of the second tool) using artificial intelligence to initiate a recommended action. In an example, the contextual information further includes sample AI input(s) and sample contextual information (e.g., sample dialogs with the AI model 1116 and/or sample descriptions of tools).

In an example data item particularity embodiment, the information gather logic 1118 causes (e.g., triggers) the AI model 1116 to analyze (e.g., develop and/or refine an understanding of) the second AI input 1152, the second contextual information (including the description of the second tool), relationships between any of the foregoing, and confidences in those relationships. In an aspect, the information gather logic 1118 causes the AI model 1116 to compare features of the second AI input 1152 and the second contextual information (including the description of the second tool) using artificial intelligence to gather information regarding a particular data item or a particular subset of the plurality of data items. In an example, the second contextual information further includes sample AI input(s) and sample contextual information (e.g., sample descriptions of tools).

In an example preliminary question embodiment, the information gather logic 1118 causes (e.g., triggers) the AI model 1116 to analyze (e.g., develop and/or refine an understanding of) the second AI input 1152, the second contextual information (including the first data items in the first subset of the data items 1128, the second data items in the second subset of the data items 1128, and/or the third data items in the third subset of the data items 1128), relationships between any of the foregoing, and confidences in those relationships. In an aspect, the information gather logic 1118 causes the AI model 1116 to compare features of the second AI input 1152 and the second contextual information (including the first data items in the first subset of the data items 1128, the second data items in the second subset of the data items 1128, and/or the third data items in the third subset of the data items 1128) using artificial intelligence to generate a preliminary question regarding the application. In an example, the second contextual information further includes sample AI input(s) and sample contextual information (e.g., sample first data items, sample second data items, and/or sample third data items).

In an example follow-up question embodiment, the root cause logic 1114 causes (e.g., triggers) the AI model 1116 to analyze (e.g., develop and/or refine an understanding of) the AI input(s) 1142, the contextual information (including the first data items in the first subset of the data items 1128, the second data items in the second subset of the data items 1128, and/or the third data items in the third subset of the data items 1128), relationships between any of the foregoing, and confidences in those relationships. In an aspect, the root cause logic 1114 causes the AI model 1116 to compare features of the AI input(s) 1142 and the contextual information (including the first data items in the first subset of the data items 1128, the second data items in the second subset of the data items 1128, and/or the third data items in the third subset of the data items 1128) using artificial intelligence to generate a follow-up question associated with a root cause of a runtime issue. In an example, the contextual information further includes sample AI input(s) and sample contextual information (e.g., sample first data items, sample second data items, and/or sample third data items).

In an example issue prioritization embodiment, the information gather logic 1118 causes (e.g., triggers) the AI model 1116 to analyze (e.g., develop and/or refine an understanding of) the second AI input 1152, the second contextual information (including the dialog with the AI model 1116), relationships between any of the foregoing, and confidences in those relationships. In an aspect, the information gather logic 1118 causes the AI model 1116 to compare features of the second AI input 1152 and the second contextual information (including the dialog with the AI model 1116) using artificial intelligence to prioritize issues that occur with regard to respective data items, which are included in the data items 1128. In an example, the second contextual information further includes sample AI input(s) and sample contextual information (e.g., sample dialogs with the AI model 1116).

In some example embodiments, the AI model 1116 includes a neural network that uses the artificial intelligence to determine (e.g., predict) relationships between any of the AI inputs described herein and any of the corresponding contextual information and confidences in the relationships. The neural network uses those relationships to generate the corresponding AI responses. In an example, attributes of the AI input, the contextual information, and potentially example AI input(s) and example AI response(s) to the AI input(s) are compared to determine similarities and differences between those attributes. In accordance with this example, the neural network uses those similarities and differences to generate the corresponding AI responses.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the root cause logic 1114 and/or the information gathering logic 1118 employs a feed forward neural network to train the AI model 1116, which is used to determine AI-based confidences. In an example, such AI-based confidences are used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. In an example, the transformer is trained to identify the context of each portion using any suitable technique, such as gradient descent.

In an example embodiment, the transformer-based neural network generates a runtime issue model (e.g., to determine that an application has a runtime issue and/or to determine a root cause of the runtime issue); a recommended action model (e.g., to initiate a recommended action); a data item particularity model (e.g., to gather information regarding a particular data item or a particular subset of the plurality of data items); a preliminary question model (e.g., to generate a preliminary question regarding an application); a follow-up question model (e.g., to generate a follow-up question associated with the root cause of a runtime issue); and/or an issue prioritization model (e.g., to prioritize issues that occur with regard to respective data items) by utilizing information, such as AI inputs, contextual information, relationships between any of the foregoing, and AI-based confidences that are derived therefrom.

In example embodiments, the root cause logic 1114 and/or the information gathering logic 1118 includes training logic, and the AI model includes inference logic. The training logic is configured to train AI algorithm(s) of the AI model 1116 that the inference logic uses to determine (e.g., infer) the AI-based confidences. In an example, the training logic provides sample AI inputs and sample contextual information as inputs to the AI algorithm(s) to train the AI algorithm(s). In another example, the sample data is labeled. In yet another example, the AI algorithm(s) are configured to derive relationships between the features (e.g., the AI input and the contextual information) and the resulting AI-based confidences. The inference logic is configured to utilize the AI algorithm(s), which are trained by the training logic, to determine the AI-based confidence when the features are provided as inputs to the algorithm.

In an example embodiment, the AI model 1116 is a generative language model. A generative language model is an AI model that is capable of generating original text output based on sample data. Examples of a generative language model include but are not limited to a generative pre-trained transformer 3 (GPT-3®) model and a generative pre-trained transformer 4 (GPT-4®) model, developed and distributed by OpenAI, Inc.; a Phi™ model and a Turing-NLG™ model, developed and distributed by Microsoft Corporation; a large language model Meta AI (LLaMA®) model, developed and distributed by Meta Platforms Inc.; a language model for dialogue applications (LaMDA®) model and a Gemini® model, developed and distributed by Google LLC; and a BigScience large open-science open-access multilingual language model (BLOOM) model, developed and distributed by the BigScience collaborative initiative. A generative language model may use any suitable relevancy determination and/or ranking technique. In an example, the generative language model uses a BM25 (Okapi BM25) ranking function to perform its analysis (e.g., based on keywords).

In another example embodiment, the AI model 1116 is a large language model (LLM). A large language model is an artificial neural network that is capable of performing natural language processing (NLP) tasks. In an example, the large language model uses a transformer model to perform the NLP tasks. In an aspect, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (PaLM®) model and the Gemini® model, developed and distributed by Google LLC.

In yet another example embodiment, the AI model 1116 is an embedding model. An embedding model is an AI model that uses deep learning to convert data into vectors, which represent attributes of the data, and that compares at least a subset of the vectors to determine an extent to which the vectors that are included in the subset are similar. In an aspect, each vector represents a semantic meaning of one or more AI inputs, one or more instances of contextual information, and/or one or more AI responses. In another aspect, an embedding is a numerical representation of data (e.g., one or more data items, a tool description, or a dialog with an AI model (e.g., AI model 1116)). In an example of this aspect, the embedding is generated by converting the data (e.g., text) into a vector (e.g., an array of numbers). In another example of this aspect, the embedding represents the meaning and the context of the data. In another example of this aspect, embeddings serve as generic representations of a corpus of data without requiring explicit feature engineering. In an aspect of this embodiment, the AI model 1116 generates AI response(s) (e.g., AI response(s) 1144 and/or second AI response 1154) to AI input(s) (AI input(s) 1142 and/or second AI input 1152) described herein using an embedding model. In an example of this aspect, the embedding model is an encoder-only model. One example of an encoder-only model is the bidirectional encoder representations from transformers (BERT™) model, which is developed and distributed by Google LLC. In another example of this aspect, the embedding model is a decoder-only model. In yet another example of this aspect, the embedding model is an encoder-decoder model. One example of an encoder-decoder model is the FLAN-T5™ model, which is developed and distributed by Google LLC. An embedding that represents multiple data items may be a combination (e.g., average or median) of respective embeddings of the data items.

In still another example embodiment, any one or more of the AI model 1116 includes multiple types of AI models. In an example, weights are applied to the responses generated by the respective types of AI models. In an aspect, the multiple types of AI models include a generative AI model and an embedding model. In an example of this aspect, a first weight is applied to a first response generated by the generative AI model to provide a first weighted response, and a second weight that is different from the first weight is applied to a second response of the embedding model to provide a second weighted response. In accordance with this example, the AI model 1116 combines (e.g., sums) the first weighted response and the second weighted response to generate a combined response of the AI model 1116.

In an example implementation, the computing system 1100 does not include one or more of the AI-based runtime issue root cause determination logic 1108, the store 1110, the subset determination logic 1112, the root cause logic 1114, the AI model 1116, the information gathering logic 1118, the visual representation logic 1120, the modification logic 1122, the presentation logic 1124, and/or the tool execution logic 1126. In another example implementation, the computing system 1100 includes component(s) in addition to or in lieu of the AI-based runtime issue root cause determination logic 1108, the store 1110, the subset determination logic 1112, the root cause logic 1114, the AI model 1116, the information gathering logic 1118, the visual representation logic 1120, the modification logic 1122, the presentation logic 1124, and/or the tool execution logic 1126.

Although the operations of some of the disclosed methods are described in a particular, sequential order for convenient presentation, it should be understood that this manner of description encompasses rearrangement, unless a particular ordering is required by specific language set forth herein. In an example, operations described sequentially are in some cases rearranged or performed concurrently. Moreover, for the sake of simplicity, the attached figures may not show the various ways in which the disclosed methods may be used in conjunction with other methods.

Any one or more of the AI-based runtime issue root cause determination logic 108, the AI model 112, the application 114, the AI-based runtime issue root cause determination logic 1108, the store 1110, the subset determination logic 1112, the root cause logic 1114, the AI model 1116, the information gathering logic 1118, the visual representation logic 1120, the modification logic 1122, the presentation logic 1124, the tool execution logic 1126, flowchart 200, flowchart 300, flowchart 400, flowchart 500, flowchart 600, flowchart 700, flowchart 800, flowchart 900, and/or flowchart 1000 may be implemented in hardware, software, firmware, or any combination thereof.

For example, any one or more of the AI-based runtime issue root cause determination logic 108, the AI model 112, the application 114, the AI-based runtime issue root cause determination logic 1108, the store 1110, the subset determination logic 1112, the root cause logic 1114, the AI model 1116, the information gathering logic 1118, the visual representation logic 1120, the modification logic 1122, the presentation logic 1124, the tool execution logic 1126, flowchart 200, flowchart 300, flowchart 400, flowchart 500, flowchart 600, flowchart 700, flowchart 800, flowchart 900, and/or flowchart 1000 may be implemented, at least in part, as computer program code configured to be executed in one or more processors.

In another example, any one or more of the AI-based runtime issue root cause determination logic 108, the AI model 112, the application 114, the AI-based runtime issue root cause determination logic 1108, the store 1110, the subset determination logic 1112, the root cause logic 1114, the AI model 1116, the information gathering logic 1118, the visual representation logic 1120, the modification logic 1122, the presentation logic 1124, the tool execution logic 1126, flowchart 200, flowchart 300, flowchart 400, flowchart 500, flowchart 600, flowchart 700, flowchart 800, flowchart 900, and/or flowchart 1000 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. In an example, a SoC includes an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

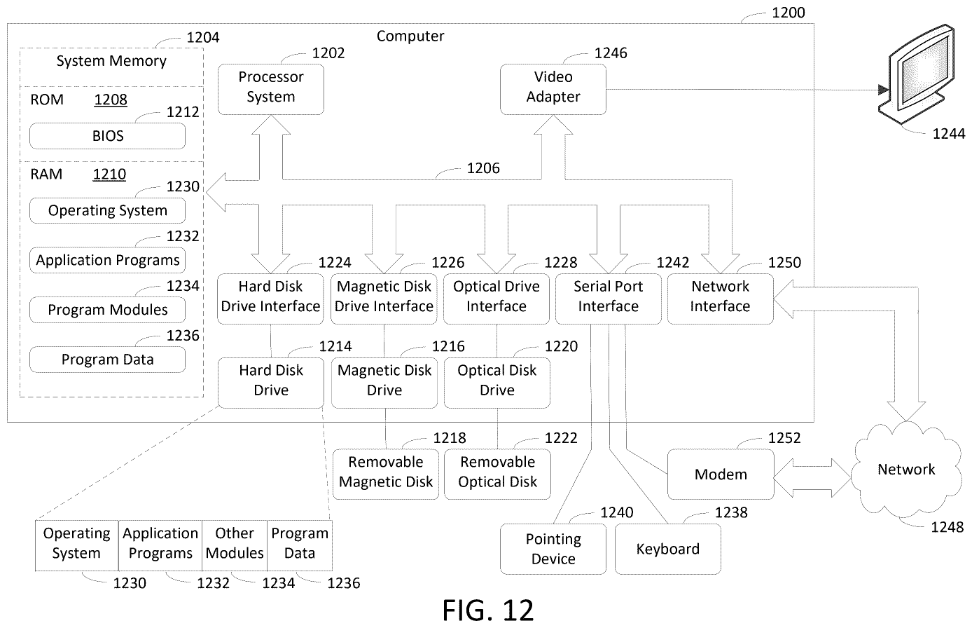

(A1) A first example system (FIG. 1, 102A-102M, 106A-106N; FIG. 11, 1100; FIG. 12, 1200) comprises a processor system (FIGS. 12, 1202) and a memory (FIG. 12, 1204, 1208, 1210) that stores computer-executable instructions. The computer-executable instructions are executable by the processor system to at least receive (FIG. 2, 202) a user input (FIG. 11, 1130) via a user interface in an application development environment. The user input inquires about a root cause of a runtime issue encountered by an application (FIG. 1, 114) that is under development. The computer-executable instructions are executable by the processor system further to at least determine (FIG. 2, 204) a particular subset of a plurality of data items (FIG. 11, 1128) regarding the application as a result of the particular subset being relevant to the runtime issue. The particular subset is a first subset of the plurality of data items that defines an application model that includes definitions and runtime information regarding a plurality of resources (FIG. 1, 118) that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application. The computer-executable instructions are executable by the processor system further to at least cause (FIG. 2, 206) an AI model (FIG. 1, 112; FIG. 11, 1116) to determine the root cause of the runtime issue by providing an AI input (FIG. 11, 1142) together with contextual information to the AI model. The AI input requests a determination of the root cause of the runtime issue and indicates a tool (FIG. 1, 116) that is configured to dynamically gather identified data items in the particular subset of the plurality of data items from at least a subset of the plurality of resources while the application is executing. The contextual information includes a description (FIG. 11, 1146) of the tool. The description of the tool being included in the contextual information enables the AI model to determine the root cause of the runtime issue by using the tool to dynamically gather the identified data items from at least the subset of the plurality of resources while the application is executing. The computer-executable instructions are executable by the processor system further to at least receive (FIG. 2, 208) an AI response (FIG. 11, 1144) from the AI model in response to the AI input, the AI response indicating the root cause of the runtime issue. The computer-executable instructions are executable by the processor system further to at least, in response to the user input, provide (FIG. 2, 210) an indication (FIG. 11, 1164) of the root cause of the runtime issue via the user interface.
(A2) In the first example system of A1, wherein the contextual information includes the description of the tool and at least one of first data items in the first subset of the plurality of data items, second data items in the second subset of the plurality of data items, or third data items in the third subset of the plurality of data items.
(A3) In the first example system of any of A1-A2, wherein the computer-executable instructions are executable by the processor system to at least: cause the AI model to determine the root cause of the runtime issue by using the tool to dynamically gather the identified data items from at least the subset of the plurality of resources while the application is executing.
(A4) In the first example system of any of A1-A3, wherein the computer-executable instructions are executable by the processor system to at least: receive an intermediate AI response from the AI model in response to the AI input, the intermediate AI response indicating that the tool is to be used to dynamically gather the identified data items; receive a request from the tool, the request requesting authorization for the tool to dynamically gather the identified data items; provide an inquiry via the user interface, the inquiry requesting the authorization for the tool to dynamically gather the identified data items; in response to the inquiry being provided, receive the authorization via the user interface; in response to the authorization being received, provide an indication of the authorization to the tool in response to the request from the tool; and receive the AI response from the AI model further in response to the indication of the authorization being provided to the tool.
(A5) In the first example system of any of A1-A4, wherein the user interface is in an integrated development environment that executes on the computing system; wherein the computer-executable instructions are executable by the processor system to cause the integrated development environment to at least: receive the user input; determine the particular subset of the plurality of data items; cause the AI model to determine the root cause of the runtime issue; and receive the AI response at the integrated development environment.
(A6) In the first example system of any of A1-A5, wherein the AI response further indicates a recommended action to resolve the runtime issue; and wherein the computer-executable instructions are executable by the processor system further to at least: provide an indication of the recommended action via the user interface.
(A7) In the first example system of any of A1-A6, wherein the computer-executable instructions are executable by the processor system to at least: provide an inquiry via the user interface, the inquiry soliciting authorization for the AI model to initiate the recommended action; in response to the inquiry being provided, receive the authorization via the user interface; and in response to the authorization being received, cause the AI model to initiate the recommended action by providing a second AI input together with second contextual information to the AI model, the second AI input requesting initiation of the recommended action, the second contextual information including a dialog with the AI model that includes the AI input, the contextual information, and the AI response.
(A8) In the first example system of any of A1-A7, wherein the computer-executable instructions are executable by the processor system further to at least: select a second tool from a plurality of tools as a result of the second tool being configured to perform the recommended action; wherein the second AI input indicates the second tool; and wherein the second contextual information includes a description of the second tool, wherein the description of the second tool being included in the second contextual information enables the AI model to initiate the recommended action using the second tool.
(A9) In the first example system of any of A1-A8, wherein the second AI input requests confirmation as to whether performance of the recommended action resolves the runtime issue; and wherein the computer-executable instructions are executable by the processor system further to at least: in response to causing the AI model to initiate the recommended action, receive confirmation from the AI model, the confirmation indicating that the runtime issue is resolved.
(A10) In the first example system of any of A1-A9, wherein the computer-executable instructions are executable by the processor system further to at least: determine that a selectable interface element associated with a particular data item in the plurality of data items is selected via the user interface, the selectable interface element configured to trigger generation of a pre-defined user input as a result of the selectable interface element being selected, the pre-defined user input requesting information regarding the particular data item; receive the pre-defined user input as a result of the selectable interface element being selected; cause the AI model to gather the information regarding the particular data item by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receive a second AI response from the AI model in response to the second AI input, the second AI response including the information regarding the particular data item; and in response to the pre-defined user input, provide the information via the user interface.
(A11) In the first example system of any of A1-A10, wherein the computer-executable instructions are executable by the processor system further to at least: provide a plurality of respective visual representations of the plurality of data items regarding the application via the user interface; modify the user interface to focus on a subset of the respective visual representations that corresponds to the particular subset of the plurality of data items in response to a user-generated command; and present a selectable interface element associated with the particular subset of the plurality of data items via the user interface as a result of the user interface being modified to focus on the subset of the respective visual representations that corresponds to the particular subset of the plurality of data items, the selectable interface element configured to trigger generation of a pre-defined user input as a result of the selectable interface element being selected, the pre-defined user input requesting information regarding the particular subset of the plurality of data items; receive the pre-defined user input as a result of the selectable interface element being selected; cause the AI model to gather the information regarding the particular subset of the plurality of data items by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receive a second AI response from the AI model in response to the second AI input, the second AI response including the information regarding the particular subset of the plurality of data items; and in response to the pre-defined user input, provide the information via the user interface.
(A12) In the first example system of any of A1-A11, wherein the computer-executable instructions are executable by the processor system further to at least: prior to causing the AI model to determine the root cause of the runtime issue, cause the AI model to generate a preliminary question regarding the application by providing a second AI input together with second contextual information to the AI model, the second AI input requesting generation of the preliminary question, the second contextual information including at least one of first data items in the first subset of the plurality of data items, second data items in the second subset of the plurality of data items, or third data items in the third subset of the plurality of data items; receive a second AI response from the AI model in response to the second AI input, the second AI response including the preliminary question; and in response to receipt of the second AI response, provide a selectable interface element that includes the preliminary question in the user interface, the selectable interface element configured to trigger the AI model to generate an answer to the preliminary question as a result of the selectable interface element being selected.
(A13) In the first example system of any of A1-A12, wherein the computer-executable instructions are executable by the processor system further to at least: in response to receipt of the AI response from the AI model, cause the AI model to generate a follow-up question associated with the root cause of the runtime issue by providing a second AI input together with second contextual information to the AI model, the second AI input requesting generation of the follow-up question, the second contextual information including a dialog with the AI model that includes the AI input, the contextual information, and the AI response; receive a second AI response from the AI model in response to the second AI input, the second AI response including the follow-up question; and in response to receipt of the second AI response, provide a selectable interface element that includes the follow-up question in the user interface, the selectable interface element configured to trigger the AI model to generate an answer to the follow-up question as a result of the selectable interface element being selected.
(A14) In the first example system of any of A1-A13, wherein the computer-executable instructions are executable by the processor system further to at least: cause the AI model to prioritize issues that occur with regard to respective data items in the plurality of data items by providing a second AI input together with second contextual information to the AI model, the second AI input requesting prioritization of the issues, the second contextual information including at least the respective data items; receive a second AI response from the AI model in response to the second AI input, the second AI response including a prioritized listing of the issues, the prioritized listing indicating the issues and respective priorities that are assigned to the issues; and in response to receipt of the second AI response, provide an indication of the prioritized listing via the user interface.
(B1) A second example system (FIG. 1, 102A-102M, 106A-106N; FIG. 11, 1100; FIG. 12, 1200) comprises a processor system (FIG. 12, 1202) and a memory (FIG. 12, 1204, 1208, 1210) that stores computer-executable instructions. The computer-executable instructions are executable by the processor system to at least receive (FIG. 10, 1002) a user input (FIG. 11, 1130) via a user interface in an application development environment, the user input inquiring whether an application (FIG. 1, 114) that is under development has a runtime issue. The computer-executable instructions are executable by the processor system further to at least determine (FIG. 10, 1004) a particular subset of a plurality of data items (FIG. 11, 1128) that has a relevance to a determination whether the application has the runtime issue that satisfies a relevance criterion. The particular subset is a first subset of the plurality of data items that defines an application model that includes definitions and runtime information regarding a plurality of resources (FIG. 1, 118) that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application. The computer-executable instructions are executable by the processor system further to at least cause (FIG. 10, 1006) an AI model (FIG. 1, 112; FIG. 11, 1116) to determine that the application has the runtime issue and to determine a root cause of the runtime issue by providing an AI input (FIG. 11, 1142) together with contextual information to the AI model. The AI input requests a determination of whether the application has the runtime issue and indicates a tool (FIG. 1, 116) that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. The computer-executable instructions are executable by the processor system further to at least receive (FIG. 10, 1008) an AI response (FIG. 11, 1144) from the AI model in response to the AI input. The AI response indicates that the application has the runtime issue and further indicates the root cause of the runtime issue. The computer-executable instructions are executable by the processor system further to at least, in response to the user input, provide (FIG. 10, 1010) a first indication that the application has the runtime issue and a second indication of the root cause of the runtime issue via the user interface.
(B2) In the second example system of B1, wherein the contextual information includes the description of the tool and at least one of first data items in the first subset of the plurality of data items, second data items in the second subset of the plurality of data items, or third data items in the third subset of the plurality of data items.
(B3) In the second example system of any of B1-B2, wherein the computer-executable instructions are executable by the processor system to at least: cause the AI model to determine the root cause of the runtime issue by using the tool to dynamically gather the identified data items from at least the subset of the plurality of resources while the application is executing.
(B4) In the second example system of any of B1-B3, wherein the computer-executable instructions are executable by the processor system to at least: receive an intermediate AI response from the AI model in response to the AI input, the intermediate AI response indicating that the tool is to be used to dynamically gather the identified data items; receive a request from the tool, the request requesting authorization for the tool to dynamically gather the identified data items; provide an inquiry via the user interface, the inquiry requesting the authorization for the tool to dynamically gather the identified data items; in response to the inquiry being provided, receive the authorization via the user interface; in response to the authorization being received, provide an indication of the authorization to the tool in response to the request from the tool; and receive at least a portion of the AI response that indicates the root cause of the runtime issue in response to the indication of the authorization being provided to the tool.
(B5) In the second example system of any of B1-B4, wherein the user interface is in an integrated development environment that executes on the computing system; and wherein the computer-executable instructions are executable by the processor system to cause the integrated development environment to at least: receive the user input; determine the particular subset of the plurality of data items; cause the AI model to determine that the application has the runtime issue and to determine the root cause of the runtime issue; and receive the AI response.
(B6) In the second example system of any of B1-B5, wherein the AI response further indicates a recommended action to resolve the runtime issue; and wherein the computer-executable instructions are executable by the processor system further to at least: provide an indication of the recommended action via the user interface.
(B7) In the second example system of any of B1-B6, wherein the computer-executable instructions are executable by the processor system to at least: provide an inquiry via the user interface, the inquiry soliciting authorization for the AI model to initiate the recommended action; in response to the inquiry being provided, receive the authorization via the user interface; and in response to the authorization being received, cause the AI model to initiate the recommended action by providing a second AI input together with second contextual information to the AI model, the second AI input requesting initiation of the recommended action, the second contextual information including a dialog with the AI model that includes the AI input, the contextual information, and the AI response.
(B8) In the second example system of any of B1-B7, wherein the computer-executable instructions are executable by the processor system further to at least: select a second tool from a plurality of tools as a result of the second tool being configured to perform the recommended action; wherein the second AI input indicates the second tool; and wherein the second contextual information includes a description of the second tool, wherein the description of the second tool being included in the second contextual information enables the AI model to initiate the recommended action using the second tool.
(B9) In the second example system of any of B1-B8, wherein the second AI input requests confirmation as to whether performance of the recommended action resolves the runtime issue; and wherein the computer-executable instructions are executable by the processor system further to at least: in response to causing the AI model to initiate the recommended action, receive confirmation from the AI model, the confirmation indicating that the runtime issue is resolved.
(B10) In the second example system of any of B1-B9, wherein the computer-executable instructions are executable by the processor system further to at least: determine that a selectable interface element associated with a particular data item in the plurality of data items is selected via the user interface, the selectable interface element configured to trigger generation of a pre-defined user input as a result of the selectable interface element being selected, the pre-defined user input requesting information regarding the particular data item; receive the pre-defined user input as a result of the selectable interface element being selected; cause the AI model to gather the information regarding the particular data item by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receive a second AI response from the AI model in response to the second AI input, the second AI response including the information regarding the particular data item; and in response to the pre-defined user input, provide the information via the user interface.
(B11) In the second example system of any of B1-B10, wherein the computer-executable instructions are executable by the processor system further to at least: provide a plurality of respective visual representations of the plurality of data items regarding the application via the user interface; modify the user interface to focus on a subset of the respective visual representations that corresponds to the particular subset of the plurality of data items in response to a user-generated command; present a selectable interface element associated with the particular subset of the plurality of data items via the user interface as a result of the user interface being modified to focus on the subset of the respective visual representations that corresponds to the particular subset of the plurality of data items, the selectable interface element configured to trigger generation of a pre-defined user input as a result of the selectable interface element being selected, the pre-defined user input requesting information regarding the particular subset of the plurality of data items; receive the pre-defined user input as a result of the selectable interface element being selected; cause the AI model to gather the information regarding the particular subset of the plurality of data items by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receive a second AI response from the AI model in response to the second AI input, the second AI response including the information regarding the particular subset of the plurality of data items; and in response to the pre-defined user input, provide the information via the user interface.
(B12) In the second example system of any of B1-B11, wherein the computer-executable instructions are executable by the processor system further to at least: prior to causing the AI model to determine that the application has the runtime issue, cause the AI model to generate a preliminary question regarding the application by providing a second AI input together with second contextual information to the AI model, the second AI input requesting generation of the preliminary question, the second contextual information including at least one of first data items in the first subset of the plurality of data items, second data items in the second subset of the plurality of data items, or third data items in the third subset of the plurality of data items; receive a second AI response from the AI model in response to the second AI input, the second AI response including the preliminary question; and in response to receipt of the second AI response, provide a selectable interface element that includes the preliminary question in the user interface, the selectable interface element configured to trigger the AI model to generate an answer to the preliminary question as a result of the selectable interface element being selected.
(B13) In the second example system of any of B1-B12, wherein the computer-executable instructions are executable by the processor system further to at least: in response to receipt of the AI response from the AI model, cause the AI model to generate a follow-up question associated with the root cause of the runtime issue by providing a second AI input together with second contextual information to the AI model, the second AI input requesting generation of the follow-up question, the second contextual information including a dialog with the AI model that includes the AI input, the contextual information, and the AI response; receive a second AI response from the AI model in response to the second AI input, the second AI response including the follow-up question; and in response to receipt of the second AI response, provide a selectable interface element that includes the follow-up question in the user interface, the selectable interface element configured to trigger the AI model to generate an answer to the follow-up question as a result of the selectable interface element being selected.
(B14) In the second example system of any of B1-B13, wherein the computer-executable instructions are executable by the processor system further to at least: cause the AI model to prioritize issues that occur with regard to respective data items in the plurality of data items by providing a second AI input together with second contextual information to the AI model, the second AI input requesting prioritization of the issues, the second contextual information including at least the respective data items; receive a second AI response from the AI model in response to the second AI input, the second AI response including a prioritized listing of the issues, the prioritized listing indicating the issues and respective priorities that are assigned to the issues; and in response to receipt of the second AI response, provide an indication of the prioritized listing via the user interface.
(C1) A first example method is implemented by a computing system (FIG. 1, 102A-102M, 106A-106N; FIG. 10, 1000; FIG. 11, 1100). The method comprises receiving (FIG. 2, 202) a user input (FIG. 11, 1130) via a user interface in an application development environment. The user input inquires about a root cause of a runtime issue encountered by an application (FIG. 1, 114) that is under development. The method further comprises determining (FIG. 2, 204) a particular subset of a plurality of data items (FIG. 11, 1128) regarding the application as a result of the particular subset being relevant to the runtime issue. The particular subset is a first subset of the plurality of data items that defines an application model that includes definitions and runtime information regarding a plurality of resources (FIG. 1, 118) that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application. The method further comprises causing (FIG. 2, 206) an AI model (FIG. 1, 112; FIG. 11, 1116) to determine a root cause of the runtime issue by providing an AI input together with contextual information to the AI model. The AI input requests a determination of the root cause of the runtime issue and indicating a tool (FIG. 1, 116) that is configured to dynamically gather identified data items in the particular subset of the plurality of data items from at least a subset of the plurality of resources while the application is executing. The contextual information includes a description (FIG. 11, 1146) of the tool. The description of the tool being included in the contextual information enables the AI model to determine the root cause of the runtime issue by using the tool to dynamically gather the identified data items from at least the subset of the plurality of resources while the application is executing. The method further comprises receiving (FIG. 2, 208) an AI response (FIG. 11, 1144) from the AI model in response to the AI input. The AI response indicates the root cause of the runtime issue. The method further comprises, in response to the user input, providing (FIG. 2, 210) an indication (FIG. 11, 1164) of the root cause of the runtime issue via the user interface.
(C2) In the first example method of C1, wherein the contextual information includes the description of the tool and at least one of first data items in the first subset of the plurality of data items, second data items in the second subset of the plurality of data items, or third data items in the third subset of the plurality of data items.
(C3) In the first example method of any of C1-C2, wherein causing the AI model to determine the root cause of the runtime issue comprises: causing the AI model to determine the root cause of the runtime issue by using the tool to dynamically gather the identified data items from at least the subset of the plurality of resources while the application is executing.
(C4) In the first example method of any of C1-C3, wherein causing the AI model to determine the root cause of the runtime issue by using the tool comprises: receiving an intermediate AI response from the AI model in response to the AI input, the intermediate AI response indicating that the tool is to be used to dynamically gather the identified data items; receiving a request from the tool, the request requesting authorization for the tool to dynamically gather the identified data items; providing an inquiry via the user interface, the inquiry requesting the authorization for the tool to dynamically gather the identified data items; in response to providing the inquiry, receiving the authorization via the user interface; and in response to receiving the authorization, providing an indication of the authorization to the tool in response to the request from the tool; and wherein receiving the AI response from the AI model comprises: receiving the AI response from the AI model further in response to the indication of the authorization being provided to the tool.
(C5) In the first example method of any of C1-C4, wherein the user interface is in an integrated development environment that executes on the computing system; wherein receiving the user input comprises: receiving the user input at the integrated development environment; wherein determining the particular subset of the plurality of data items comprises: determining, by the integrated development environment, the particular subset of the plurality of data items; wherein causing the AI model to determine the root cause of the runtime issue comprises: causing, by the integrated development environment, the AI model to determine the root cause of the runtime issue; and wherein receiving the AI response comprises: receiving the AI response at the integrated development environment.
(C6) In the first example method of any of C1-C5, wherein the AI response further indicates a recommended action to resolve the runtime issue; and wherein the method further comprises: providing an indication of the recommended action via the user interface.
(C7) In the first example method of any of C1-C6, wherein providing the indication of the recommended action comprises: providing an inquiry via the user interface, the inquiry soliciting authorization for the AI model to initiate the recommended action; and wherein the method further comprises: in response to providing the inquiry, receiving the authorization via the user interface; and in response to receiving the authorization, causing the AI model to initiate the recommended action by providing a second AI input together with second contextual information to the AI model, the second AI input requesting initiation of the recommended action, the second contextual information including a dialog with the AI model that includes the AI input, the contextual information, and the AI response.
(C8) In the first example method of any of C1-C7, further comprising: selecting a second tool from a plurality of tools as a result of the second tool being configured to perform the recommended action; wherein the second AI input indicates the second tool; and wherein the second contextual information includes a description of the second tool, wherein the description of the second tool being included in the second contextual information enables the AI model to initiate the recommended action using the second tool.
(C9) In the first example method of any of C1-C8, wherein the second AI input requests confirmation as to whether performance of the recommended action resolves the runtime issue; and wherein the method further comprises: in response to causing the AI model to initiate the recommended action, receiving confirmation from the AI model, the confirmation indicating that the runtime issue is resolved.
(C10) In the first example method of any of C1-C9, further comprising: determining that a selectable interface element associated with a particular data item in the plurality of data items is selected via the user interface, the selectable interface element configured to trigger generation of a pre-defined user input as a result of the selectable interface element being selected, the pre-defined user input requesting information regarding the particular data item; receiving the pre-defined user input as a result of the selectable interface element being selected; causing the AI model to gather the information regarding the particular data item by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receiving a second AI response from the AI model in response to the second AI input, the second AI response including the information regarding the particular data item; and in response to the pre-defined user input, providing the information via the user interface.
(C11) In the first example method of any of C1-C10, further comprising: providing a plurality of respective visual representations of the plurality of data items regarding the application via the user interface; modifying the user interface to focus on a subset of the respective visual representations that corresponds to the particular subset of the plurality of data items in response to a user-generated command; presenting a selectable interface element associated with the particular subset of the plurality of data items via the user interface as a result of the user interface being modified to focus on the subset of the respective visual representations that corresponds to the particular subset of the plurality of data items, the selectable interface element configured to trigger generation of a pre-defined user input as a result of the selectable interface element being selected, the pre-defined user input requesting information regarding the particular subset of the plurality of data items; receiving the pre-defined user input as a result of the selectable interface element being selected; causing the AI model to gather the information regarding the particular subset of the plurality of data items by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receiving a second AI response from the AI model in response to the second AI input, the second AI response including the information regarding the particular subset of the plurality of data items; and in response to the pre-defined user input, providing the information via the user interface.
(C12) In the first example method of any of C1-C11, further comprising: prior to causing the AI model to determine the root cause of the runtime issue, causing the AI model to generate a preliminary question regarding the application by providing a second AI input together with second contextual information to the AI model, the second AI input requesting generation of the preliminary question, the second contextual information including at least one of first data items in the first subset of the plurality of data items, second data items in the second subset of the plurality of data items, or third data items in the third subset of the plurality of data items; receiving a second AI response from the AI model in response to the second AI input, the second AI response including the preliminary question; and in response to receiving the second AI response, providing a selectable interface element that includes the preliminary question in the user interface, the selectable interface element configured to trigger the AI model to generate an answer to the preliminary question as a result of the selectable interface element being selected.
(C13) In the first example method of any of C1-C12, further comprising: in response to receiving the AI response from the AI model, causing the AI model to generate a follow-up question associated with the root cause of the runtime issue by providing a second AI input together with second contextual information to the AI model, the second AI input requesting generation of the follow-up question, the second contextual information including a dialog with the AI model that includes the AI input, the contextual information, and the AI response; receiving a second AI response from the AI model in response to the second AI input, the second AI response including the follow-up question; and in response to receiving the second AI response, providing a selectable interface element that includes the follow-up question in the user interface, the selectable interface element configured to trigger the AI model to generate an answer to the follow-up question as a result of the selectable interface element being selected.
(C14) In the first example method of any of C1-C13, further comprising: causing the AI model to prioritize issues that occur with regard to respective data items in the plurality of data items by providing a second AI input together with second contextual information to the AI model, the second AI input requesting prioritization of the issues, the second contextual information including at least the respective data items; receiving a second AI response from the AI model in response to the second AI input, the second AI response including a prioritized listing of the issues, the prioritized listing indicating the issues and respective priorities that are assigned to the issues; and in response to receiving the second AI response, providing an indication of the prioritized listing via the user interface.
(D1) A second example method is implemented by a computing system (FIG. 1, 102A-102M, 106A-106N; FIG. 10, 1000; FIG. 11, 1100). The method comprises receiving (FIG. 10, 1002) a user input (FIG. 11, 1130) via a user interface in an application development environment, the user input inquiring whether an application (FIG. 1, 114) that is under development has a runtime issue. The method further comprises determining (FIG. 10, 1004) a particular subset of a plurality of data items (FIG. 11, 1128) that has a relevance to a determination whether the application has the runtime issue that satisfies a relevance criterion. The particular subset is a first subset of the plurality of data items that defines an application model that includes definitions and runtime information regarding a plurality of resources (FIG. 1, 118) that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application. The method further comprises causing (FIG. 10, 1006) an AI model (FIG. 1, 112; FIG. 11, 1116) to determine that the application has the runtime issue and to determine a root cause of the runtime issue by providing an AI input (FIG. 11, 1142) together with contextual information to the AI model. The AI input requests a determination of whether the application has the runtime issue and indicates a tool (FIG. 1, 116) that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. The method further comprises receiving (FIG. 10, 1008) an AI response (FIG. 11, 1144) from the AI model in response to the AI input. The AI response indicates that the application has the runtime issue and further indicates the root cause of the runtime issue. The method further comprises, in response to the user input, providing (FIG. 10, 1010) a first indication that the application has the runtime issue and a second indication of the root cause of the runtime issue via the user interface.
(D2) In the second example method of D1, wherein the contextual information includes the description of the tool and at least one of first data items in the first subset of the plurality of data items, second data items in the second subset of the plurality of data items, or third data items in the third subset of the plurality of data items.
(D3) In the second example method of any of D1-D2, wherein causing the AI model to determine that the application has the runtime issue and to determine the root cause of the runtime issue comprises: causing the AI model to determine the root cause of the runtime issue by using the tool to dynamically gather the identified data items from at least the subset of the plurality of resources while the application is executing.
(D4) In the second example method of any of D1-D3, wherein causing the AI model to determine the root cause of the runtime issue by using the tool comprises: receiving an intermediate AI response from the AI model in response to the AI input, the intermediate AI response indicating that the tool is to be used to dynamically gather the identified data items; receiving a request from the tool, the request requesting authorization for the tool to dynamically gather the identified data items; providing an inquiry via the user interface, the inquiry requesting the authorization for the tool to dynamically gather the identified data items; in response to providing the inquiry, receiving the authorization via the user interface; and in response to receiving the authorization, providing an indication of the authorization to the tool in response to the request from the tool; and wherein receiving the AI response from the AI model comprises: receiving at least a portion of the AI response that indicates the root cause of the runtime issue in response to the indication of the authorization being provided to the tool.
(D5) In the second example method of any of D1-D4, wherein the user interface is in an integrated development environment that executes on the computing system; wherein receiving the user input comprises: receiving the user input at the integrated development environment; wherein determining the particular subset of the plurality of data items comprises: determining the particular subset of the plurality of data items by the integrated development environment; wherein causing the AI model to determine that the application has the runtime issue and to determine the root cause of the runtime issue comprises: causing the AI model to determine that the application has the runtime issue and to determine the root cause of the runtime issue by the integrated development environment; and wherein receiving the AI response comprises: receiving the AI response at the integrated development environment.
(D6) In the second example method of any of D1-D5, wherein the AI response further indicates a recommended action to resolve the runtime issue; and wherein the method further comprises: providing an indication of the recommended action via the user interface.
(D7) In the second example method of any of D1-D6, wherein providing the indication of the recommended action comprises: providing an inquiry via the user interface, the inquiry soliciting authorization for the AI model to initiate the recommended action; and wherein the method further comprises: in response to providing the inquiry, receiving the authorization via the user interface; and in response to receiving the authorization, causing the AI model to initiate the recommended action by providing a second AI input together with second contextual information to the AI model, the second AI input requesting initiation of the recommended action, the second contextual information including a dialog with the AI model that includes the AI input, the contextual information, and the AI response.
(D8) In the second example method of any of D1-D7, further comprising: selecting a second tool from a plurality of tools as a result of the second tool being configured to perform the recommended action; wherein the second AI input indicates the second tool; and wherein the second contextual information includes a description of the second tool, wherein the description of the second tool being included in the second contextual information enables the AI model to initiate the recommended action using the second tool.
(D9) In the second example method of any of D1-D8, wherein the second AI input requests confirmation as to whether performance of the recommended action resolves the runtime issue; and wherein the method further comprises: in response to causing the AI model to initiate the recommended action, receiving confirmation from the AI model, the confirmation indicating that the runtime issue is resolved.
(D10) In the second example method of any of D1-D9, further comprising: determining that a selectable interface element associated with a particular data item in the plurality of data items is selected via the user interface, the selectable interface element configured to trigger generation of a pre-defined user input as a result of the selectable interface element being selected, the pre-defined user input requesting information regarding the particular data item; receiving the pre-defined user input as a result of the selectable interface element being selected; causing the AI model to gather the information regarding the particular data item by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receiving a second AI response from the AI model in response to the second AI input, the second AI response including the information regarding the particular data item; and in response to the pre-defined user input, providing the information via the user interface.
(D11) In the second example method of any of D1-D10, providing a plurality of respective visual representations of the plurality of data items regarding the application via the user interface; modifying the user interface to focus on a subset of the respective visual representations that corresponds to the particular subset of the plurality of data items in response to a user-generated command; presenting a selectable interface element associated with the particular subset of the plurality of data items via the user interface as a result of the user interface being modified to focus on the subset of the respective visual representations that corresponds to the particular subset of the plurality of data items, the selectable interface element configured to trigger generation of a pre-defined user input as a result of the selectable interface element being selected, the pre-defined user input requesting information regarding the particular subset of the plurality of data items; receiving the pre-defined user input as a result of the selectable interface element being selected; causing the AI model to gather the information regarding the particular subset of the plurality of data items by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool; receiving a second AI response from the AI model in response to the second AI input, the second AI response including the information regarding the particular subset of the plurality of data items; and in response to the pre-defined user input, providing the information via the user interface.
(D12) In the second example method of any of D1-D11, prior to causing the AI model to determine that the application has the runtime issue, causing the AI model to generate a preliminary question regarding the application by providing a second AI input together with second contextual information to the AI model, the second AI input requesting generation of the preliminary question, the second contextual information including at least one of first data items in the first subset of the plurality of data items, second data items in the second subset of the plurality of data items, or third data items in the third subset of the plurality of data items; receiving a second AI response from the AI model in response to the second AI input, the second AI response including the preliminary question; and in response to receiving the second AI response, providing a selectable interface element that includes the preliminary question in the user interface, the selectable interface element configured to trigger the AI model to generate an answer to the preliminary question as a result of the selectable interface element being selected.
(D13) In the second example method of any of D1-D12, in response to receiving the AI response from the AI model, causing the AI model to generate a follow-up question associated with the root cause of the runtime issue by providing a second AI input together with second contextual information to the AI model, the second AI input requesting generation of the follow-up question, the second contextual information including a dialog with the AI model that includes the AI input, the contextual information, and the AI response; receiving a second AI response from the AI model in response to the second AI input, the second AI response including the follow-up question; and in response to receiving the second AI response, providing a selectable interface element that includes the follow-up question in the user interface, the selectable interface element configured to trigger the AI model to generate an answer to the follow-up question as a result of the selectable interface element being selected.
(D14) In the second example method of any of D1-D13, further comprising: causing the AI model to prioritize issues that occur with regard to respective data items in the plurality of data items by providing a second AI input together with second contextual information to the AI model, the second AI input requesting prioritization of the issues, the second contextual information including at least the respective data items; receiving a second AI response from the AI model in response to the second AI input, the second AI response including a prioritized listing of the issues, the prioritized listing indicating the issues and respective priorities that are assigned to the issues; and in response to receiving the second AI response, providing an indication of the prioritized listing via the user interface.
(E1) A first example computer program product (FIG. 12, 1218, 1222) comprises a computer-readable storage medium having instructions recorded thereon for enabling a processor-based system (FIG. 1, 102A-102M, 106A-106N; FIG. 11, 1100; FIG. 12, 1200) to perform operations. The operations comprise receiving (FIG. 2, 202) a user input (FIG. 11, 1130) via a user interface in an application development environment. The user input inquires about a root cause of a runtime issue encountered by an application (FIG. 1, 114) that is under development. The operations further comprise determining (FIG. 2, 204) a particular subset of a plurality of data items (FIG. 11, 1128) regarding the application as a result of the particular subset being relevant to the runtime issue. The particular subset is a first subset of the plurality of data items that defines an application model that includes definitions and runtime information regarding a plurality of resources (FIG. 1, 118) that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application. The operations further comprise causing (FIG. 2, 206) an AI model (FIG. 1, 112; FIG. 11, 1116) to determine a root cause of the runtime issue by providing an AI input together with contextual information to the AI model. The AI input requests a determination of the root cause of the runtime issue and indicating a tool (FIG. 1, 116) that is configured to dynamically gather identified data items in the particular subset of the plurality of data items from at least a subset of the plurality of resources while the application is executing. The contextual information includes a description (FIG. 11, 1146) of the tool. The description of the tool being included in the contextual information enables the AI model to determine the root cause of the runtime issue by using the tool to dynamically gather the identified data items from at least the subset of the plurality of resources while the application is executing. The operations further comprise receiving (FIG. 2, 208) an AI response (FIG. 11, 1144) from the AI model in response to the AI input. The AI response indicates the root cause of the runtime issue. The operations further comprise, in response to the user input, providing (FIG. 2, 210) an indication (FIG. 11, 1164) of the root cause of the runtime issue via the user interface.
(F1) A second example computer program product (FIG. 12, 1218, 1222) comprises a computer-readable storage medium having instructions recorded thereon for enabling a processor-based system (FIG. 1, 102A-102M, 106A-106N; FIG. 11, 1100; FIG. 12, 1200) to perform operations. The operations comprise receiving (FIG. 10, 1002) a user input (FIG. 11, 1130) via a user interface in an application development environment, the user input inquiring whether an application (FIG. 1, 114) that is under development has a runtime issue. The operations further comprise determining (FIG. 10, 1004) a particular subset of a plurality of data items (FIG. 11, 1128) that has a relevance to a determination whether the application has the runtime issue that satisfies a relevance criterion. The particular subset is a first subset of the plurality of data items that defines an application model that includes definitions and runtime information regarding a plurality of resources (FIG. 1, 118) that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application. The operations further comprise causing (FIG. 10, 1006) an AI model (FIG. 1, 112; FIG. 11, 1116) to determine that the application has the runtime issue and to determine a root cause of the runtime issue by providing an AI input (FIG. 11, 1142) together with contextual information to the AI model. The AI input requests a determination of whether the application has the runtime issue and indicates a tool (FIG. 1, 116) that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. The operations further comprise receiving (FIG. 10, 1008) an AI response (FIG. 11, 1144) from the AI model in response to the AI input. The AI response indicates that the application has the runtime issue and further indicates the root cause of the runtime issue. The operations further comprise, in response to the user input, providing (FIG. 10, 1010) a first indication that the application has the runtime issue and a second indication of the root cause of the runtime issue via the user interface.
(G1) A third example computer program product (FIG. 12, 1218, 1222) comprises a computer-readable storage medium having instructions recorded thereon for enabling a processor-based system (FIG. 1, 102A-102M, 106A-106N; FIG. 11, 1100; FIG. 12, 1200) to perform operations. The operations comprise determining (FIG. 10, 1004) a particular subset of a plurality of data items (FIG. 11, 1128) that has a relevance to a determination whether an application (FIG. 1, 114) that is under development has a runtime issue that satisfies a relevance criterion. The particular subset is a first subset of the plurality of data items that defines an application model that includes definitions and runtime information regarding a plurality of resources (FIG. 1, 118) that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application. The operations further comprise, in response to detection of a triggering event (FIG. 11, 1180), causing (FIG. 10, 1006) an AI model (FIG. 1, 112; FIG. 11, 1116) to determine that the application has the runtime issue and to determine a root cause of the runtime issue by providing an AI input (FIG. 11, 1142) together with contextual information to the AI model. The AI input requests a determination of whether the application has the runtime issue and indicating a tool (FIG. 1, 116) that is configured to dynamically gather identified data items in the particular subset of the plurality of data items from at least a subset of the plurality of resources while the application is executing. The contextual information includes a description of the tool. The description of the tool being included in the contextual information enables the AI model to determine the root cause of the runtime issue by using the tool to dynamically gather the identified data items from at least the subset of the plurality of resources while the application is executing. The operations further comprise receiving (FIG. 10, 1008) an AI response (FIG. 11, 1144) from the AI model in response to the AI input. The AI response indicates that the application has the runtime issue and further indicates the root cause of the runtime issue. The operations further comprise, as a result of the AI response indicating that the application has the runtime issue and further indicating the root cause of the runtime issue, performing an action with regard to the runtime issue.

### III. Example Computer System

FIG. 12 depicts an example computer 1200 in which embodiments may be implemented. Any one or more of the user devices 102A-102M and/or any one or more of the servers 106A-106N shown in FIG. 1 and/or the computing system 1100 shown in FIG. 11 may be implemented using computer 1200, including one or more features of computer 1200 and/or alternative features. In an example, computer 1200 is a general-purpose computing device in the form of a conventional personal computer, a mobile computer, or a workstation, for example. In another example, computer 1200 is a special purpose computing device. The description of computer 1200 provided herein is provided for purposes of illustration, and is not intended to be limiting. Embodiments may be implemented in further types of computer systems, as would be known to persons skilled in the relevant art(s).

As shown in FIG. 12, computer 1200 includes a processor system 1202, a system memory 1204, and a bus 1206 that couples various system components including system memory 1204 to processor system 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1230, one or more application programs 1232, other program modules 1234, and program data 1236. In an example, application programs 1232 and/or program modules 1234 include computer program logic for implementing any one or more of (e.g., at least a portion of) the AI-based runtime issue root cause determination logic 108, the AI model 112, the application 114, the AI-based runtime issue root cause determination logic 1108, the store 1110, the subset determination logic 1112, the root cause logic 1114, the AI model 1116, the information gathering logic 1118, the visual representation logic 1120, the modification logic 1122, the presentation logic 1124, the tool execution logic 1126, flowchart 200 (including any step of flowchart 200), flowchart 300 (including any step of flowchart 300), flowchart 400 (including any step of flowchart 400), flowchart 500 (including any step of flowchart 500), flowchart 600 (including any step of flowchart 600), flowchart 700 (including any step of flowchart 700), flowchart 800 (including any step of flowchart 800), flowchart 900 (including any step of flowchart 900), and/or flowchart 1000 (including any step of flowchart 1000), as described herein.

A user may enter commands and information into the computer 1200 through input devices, such as keyboard 1238 and pointing device 1240. Other examples of an input device (not shown) include but are not limited to a microphone, a joystick, a game pad, a satellite dish, a scanner, a touch screen, a camera, an accelerometer, and a gyroscope. These and other input devices often are connected to the processor system 1202 through a serial port interface 1242 that is coupled to bus 1206, but may be connected by other interfaces, such as a parallel port, game port, or a universal serial bus (USB).

A display device 1244 (e.g., a monitor) is also connected to bus 1206 via an interface, such as a video adapter 1246. In an example, computer 1200 includes other peripheral output devices (not shown), such as speakers and printers.

Computer 1200 is connected to a network 1248 (e.g., the Internet) through a network interface 1250 (e.g., a network adapter), a modem 1252, or other means for establishing communications over the network. Modem 1252 is connected to bus 1206 via serial port interface 1242. In an example, modem 1252 is incorporated into the computer. In another example, modem 1252 is external to computer 1200.

As used herein, the terms “computer program medium” and “computer-readable storage medium” are used to generally refer to media (e.g., non-transitory media) such as the hard disk associated with hard disk drive 1214, removable magnetic disk 1218, removable optical disk 1222, as well as other media such as flash memory cards, digital video disks, random access memories (RAMs), read only memories (ROM), and the like. A computer-readable storage medium is not a signal, such as a carrier signal or a propagating signal. In an example, a computer-readable storage medium does not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1232 and other program modules 1234) may be stored on the hard disk, magnetic disk, optical disk, ROM, or RAM. Such computer programs also may be received via network interface 1250 or serial port interface 1242. Such computer programs, when executed or loaded by an application, enable computer 1200 to implement features of embodiments discussed herein. Accordingly, such computer programs represent controllers of the computer 1200.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, though each embodiment need not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
receive a user input via a user interface in an application development environment, the user input inquiring about a root cause of a runtime issue encountered by an application that is under development;
determine a particular subset of a plurality of data items regarding the application as a result of the particular subset being relevant to the runtime issue, the particular subset being a first subset of the plurality of data items that defines an application model that includes definitions and runtime information regarding a plurality of resources that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application;
cause an AI model to determine the root cause of the runtime issue by providing an AI input together with contextual information to the AI model, the AI input requesting a determination of the root cause of the runtime issue and indicating a tool that is configured to dynamically gather identified data items in the particular subset of the plurality of data items from at least a subset of the plurality of resources while the application is executing, the contextual information including a description of the tool, wherein the description of the tool being included in the contextual information enables the AI model to determine the root cause of the runtime issue by using the tool to dynamically gather the identified data items from at least the subset of the plurality of resources while the application is executing;
receive an AI response from the AI model in response to the AI input, the AI response indicating the root cause of the runtime issue; and
in response to the user input, provide an indication of the root cause of the runtime issue via the user interface.

2. The system of claim 1, wherein the contextual information includes the description of the tool and at least one of first data items in the first subset of the plurality of data items, second data items in the second subset of the plurality of data items, or third data items in the third subset of the plurality of data items.

3. The system of claim 1, wherein the computer-executable instructions are executable by the processor system to at least:
cause the AI model to determine the root cause of the runtime issue by using the tool to dynamically gather the identified data items from at least the subset of the plurality of resources while the application is executing.

4. The system of claim 3, wherein the computer-executable instructions are executable by the processor system to at least:
receive an intermediate AI response from the AI model in response to the AI input, the intermediate AI response indicating that the tool is to be used to dynamically gather the identified data items;
receive a request from the tool, the request requesting authorization for the tool to dynamically gather the identified data items;
provide an inquiry via the user interface, the inquiry requesting the authorization for the tool to dynamically gather the identified data items;
in response to the inquiry being provided, receive the authorization via the user interface;
in response to the authorization being received, provide an indication of the authorization to the tool in response to the request from the tool; and
receive the AI response from the AI model further in response to the indication of the authorization being provided to the tool.

5. The system of claim 1, wherein the user interface is in an integrated development environment that executes on the computing system;
wherein the computer-executable instructions are executable by the processor system to cause the integrated development environment to at least:
receive the user input;
determine the particular subset of the plurality of data items;
cause the AI model to determine the root cause of the runtime issue; and
receive the AI response at the integrated development environment.

6. The system of claim 1, wherein the AI response further indicates a recommended action to resolve the runtime issue; and
wherein the computer-executable instructions are executable by the processor system further to at least:
provide an indication of the recommended action via the user interface.

7. The system of claim 6, wherein the computer-executable instructions are executable by the processor system to at least:
provide an inquiry via the user interface, the inquiry soliciting authorization for the AI model to initiate the recommended action;
in response to the inquiry being provided, receive the authorization via the user interface; and
in response to the authorization being received, cause the AI model to initiate the recommended action by providing a second AI input together with second contextual information to the AI model, the second AI input requesting initiation of the recommended action, the second contextual information including a dialog with the AI model that includes the AI input, the contextual information, and the AI response.

8. The system of claim 7, wherein the computer-executable instructions are executable by the processor system further to at least:
select a second tool from a plurality of tools as a result of the second tool being configured to perform the recommended action;
wherein the second AI input indicates the second tool; and
wherein the second contextual information includes a description of the second tool, wherein the description of the second tool being included in the second contextual information enables the AI model to initiate the recommended action using the second tool.

9. The system of claim 7, wherein the second AI input requests confirmation as to whether performance of the recommended action resolves the runtime issue; and
wherein the computer-executable instructions are executable by the processor system further to at least:
in response to causing the AI model to initiate the recommended action, receive confirmation from the AI model, the confirmation indicating that the runtime issue is resolved.

10. The system of claim 1, wherein the computer-executable instructions are executable by the processor system further to at least:
determine that a selectable interface element associated with a particular data item in the plurality of data items is selected via the user interface, the selectable interface element configured to trigger generation of a pre-defined user input as a result of the selectable interface element being selected, the pre-defined user input requesting information regarding the particular data item;
receive the pre-defined user input as a result of the selectable interface element being selected;
cause the AI model to gather the information regarding the particular data item by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool;
receive a second AI response from the AI model in response to the second AI input, the second AI response including the information regarding the particular data item; and
in response to the pre-defined user input, provide the information via the user interface.

11. The system of claim 1, wherein the computer-executable instructions are executable by the processor system further to at least:
provide a plurality of respective visual representations of the plurality of data items regarding the application via the user interface;
modify the user interface to focus on a subset of the respective visual representations that corresponds to the particular subset of the plurality of data items in response to a user-generated command; and
present a selectable interface element associated with the particular subset of the plurality of data items via the user interface as a result of the user interface being modified to focus on the subset of the respective visual representations that corresponds to the particular subset of the plurality of data items, the selectable interface element configured to trigger generation of a pre-defined user input as a result of the selectable interface element being selected, the pre-defined user input requesting information regarding the particular subset of the plurality of data items;
receive the pre-defined user input as a result of the selectable interface element being selected;
cause the AI model to gather the information regarding the particular subset of the plurality of data items by providing a second AI input together with second contextual information to the AI model, the second AI input requesting the information and indicating a second tool that is configured to gather the information, the second contextual information including a description of the second tool, wherein the description of the second tool being included in the second contextual information enables the AI model to gather the information by using the second tool;
receive a second AI response from the AI model in response to the second AI input, the second AI response including the information regarding the particular subset of the plurality of data items; and
in response to the pre-defined user input, provide the information via the user interface.

12. A method implemented by a computing system, the method comprising:
receiving a user input via a user interface in an application development environment, the user input inquiring whether an application that is under development has a runtime issue;
determining a particular subset of a plurality of data items that has a relevance to a determination whether the application has the runtime issue that satisfies a relevance criterion, the particular subset being a first subset of the plurality of data items that defines an application model that includes definitions and runtime information regarding a plurality of resources that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application;
causing an AI model to determine that the application has the runtime issue and to determine a root cause of the runtime issue by providing an AI input together with contextual information to the AI model, the AI input requesting a determination of whether the application has the runtime issue and indicating a tool that is configured to dynamically gather identified data items in the particular subset of the plurality of data items from at least a subset of the plurality of resources while the application is executing, the contextual information including a description of the tool, wherein the description of the tool being included in the contextual information enables the AI model to determine the root cause of the runtime issue by using the tool to dynamically gather the identified data items from at least the subset of the plurality of resources while the application is executing;
receiving an AI response from the AI model in response to the AI input, the AI response indicating that the application has the runtime issue and further indicating the root cause of the runtime issue; and
in response to the user input, providing a first indication that the application has the runtime issue and a second indication of the root cause of the runtime issue via the user interface.

13. The method of claim 12, wherein the contextual information includes the description of the tool and at least one of first data items in the first subset of the plurality of data items, second data items in the second subset of the plurality of data items, or third data items in the third subset of the plurality of data items.

14. The method of claim 12, wherein causing the AI model to determine that the application has the runtime issue and to determine the root cause of the runtime issue comprises:
causing the AI model to determine the root cause of the runtime issue by using the tool to dynamically gather the identified data items from at least the subset of the plurality of resources while the application is executing.

15. The method of claim 14, wherein causing the AI model to determine the root cause of the runtime issue by using the tool comprises:
receiving an intermediate AI response from the AI model in response to the AI input, the intermediate AI response indicating that the tool is to be used to dynamically gather the identified data items;
receiving a request from the tool, the request requesting authorization for the tool to dynamically gather the identified data items;
providing an inquiry via the user interface, the inquiry requesting the authorization for the tool to dynamically gather the identified data items;
in response to providing the inquiry, receiving the authorization via the user interface; and
in response to receiving the authorization, providing an indication of the authorization to the tool in response to the request from the tool; and
wherein receiving the AI response from the AI model comprises:
receiving at least a portion of the AI response that indicates the root cause of the runtime issue in response to the indication of the authorization being provided to the tool.

16. The method of claim 12, wherein the AI response further indicates a recommended action to resolve the runtime issue; and
wherein the method further comprises:
providing an indication of the recommended action via the user interface.

17. The method of claim 12, further comprising:
prior to causing the AI model to determine that the application has the runtime issue, causing the AI model to generate a preliminary question regarding the application by providing a second AI input together with second contextual information to the AI model, the second AI input requesting generation of the preliminary question, the second contextual information including at least one of first data items in the first subset of the plurality of data items, second data items in the second subset of the plurality of data items, or third data items in the third subset of the plurality of data items;
receiving a second AI response from the AI model in response to the second AI input, the second AI response including the preliminary question; and
in response to receiving the second AI response, providing a selectable interface element that includes the preliminary question in the user interface, the selectable interface element configured to trigger the AI model to generate an answer to the preliminary question as a result of the selectable interface element being selected.

18. The method of claim 12, further comprising:
in response to receiving the AI response from the AI model, causing the AI model to generate a follow-up question associated with the root cause of the runtime issue by providing a second AI input together with second contextual information to the AI model, the second AI input requesting generation of the follow-up question, the second contextual information including a dialog with the AI model that includes the AI input, the contextual information, and the AI response;
receiving a second AI response from the AI model in response to the second AI input, the second AI response including the follow-up question; and
in response to receiving the second AI response, providing a selectable interface element that includes the follow-up question in the user interface, the selectable interface element configured to trigger the AI model to generate an answer to the follow-up question as a result of the selectable interface element being selected.

19. The method of claim 12, further comprising:
causing the AI model to prioritize issues that occur with regard to respective data items in the plurality of data items by providing a second AI input together with second contextual information to the AI model, the second AI input requesting prioritization of the issues, the second contextual information including at least the respective data items;
receiving a second AI response from the AI model in response to the second AI input, the second AI response including a prioritized listing of the issues, the prioritized listing indicating the issues and respective priorities that are assigned to the issues; and
in response to receiving the second AI response, providing an indication of the prioritized listing via the user interface.

20. A computer program product comprising a computer-readable storage medium having instructions recorded thereon for enabling a processor-based system to perform operations, the operations comprising:
determining a particular subset of a plurality of data items that has a relevance to a determination whether an application that is under development has a runtime issue that satisfies a relevance criterion, the particular subset being a first subset of the plurality of data items that defines an application model that includes definitions and runtime information regarding a plurality of resources that define the application, a second subset of the plurality of data items that includes a resource log that indicates at least one of an event or an error that occurs with regard to the plurality of resources, or a third subset of the plurality of data items that includes application telemetry that indicates at least one of performance or usage of the application;
in response to detection of a triggering event, causing an AI model to determine that the application has the runtime issue and to determine a root cause of the runtime issue by providing an AI input together with contextual information to the AI model, the AI input requesting a determination of whether the application has the runtime issue and indicating a tool that is configured to dynamically gather identified data items in the particular subset of the plurality of data items from at least a subset of the plurality of resources while the application is executing, the contextual information including a description of the tool, wherein the description of the tool being included in the contextual information enables the AI model to determine the root cause of the runtime issue by using the tool to dynamically gather the identified data items from at least the subset of the plurality of resources while the application is executing;
receiving an AI response from the AI model in response to the AI input, the AI response indicating that the application has the runtime issue and further indicating the root cause of the runtime issue; and
as a result of the AI response indicating that the application has the runtime issue and further indicating the root cause of the runtime issue, performing an action with regard to the runtime issue.
